(19) United States
(12) Patent Application Publication
(10) Pub. No.: US 2025/0100249 A1
(43) Pub. Date: Mar. 27, 2025

(54) METHOD FOR PRODUCING INTEGRATED ARTICLE OF FRP WITH METAL MATERIAL

(71) Applicant: ANDOH-Corporation limited partnership company, Kanagawa (JP)

(72) Inventor: Naoki ANDOH, Kanagawa (JP)

(73) Assignee: ANDOH-Corporation limited partnership company, Kanagawa (JP)

(21) Appl. No.: 18/974,631

(22) Filed: Dec. 9, 2024

Related U.S. Application Data
(62) Division of application No. 17/693,434, filed on Mar. 14, 2022.

(30) Foreign Application Priority Data
Mar. 12, 2021 (JP) 2021-040744

(51) Int. Cl. B32B 15/14; B32B 5/02; B32B 7/12; B32B 15/04; B32B 15/20; C08J 5/12; C08J 5/24

(52) U.S. Cl. CPC B32B 15/14; B32B 5/02; B32B 5/024; B32B 7/12; B32B 15/043; B32B 15/20; C08J 5/124; C08J 5/243; B32B 2255/02; B32B 2255/26; B32B 2260/021; B32B 2260/046; B32B 2262/106; B32B 2307/732; B32B 2605/08; B32B 2605/18; C08J 2463/00

(57) ABSTRACT

A metal sheet (Al alloy A6061) with a thickness of 0.2 to 1.0 mm with one component epoxy adhesive painted on a surface thereof having been subjected to chemical treatment is joined by adhesion with a plate material of CFRP prepared by laminating CFRP prepregs having carbon fiber aligned in uni-direction or having crossing carbon fiber. A metal plate (a high strength Al alloy material) is joined by adhesion with the metal sheet to be an integrated object via a layer of cured adhesive of epoxy resin adhesive having a thickness after adhesion of 0.3 mm or more. The integrated object can endure large change of temperature because of deformation of the layer of cured adhesive. A basic technique is provided such that a structure of CFRP joined by adhesion with a high strength metal material that can endure a severe several thousand cycle thermal shock test is prepared, enabling an aircraft, an automobile and a moving-type robot to be of a lighter weight.

### CROSS-REFERENCE TO RELATED APPLICATION

This application is a divisional of and claims the priority benefit of U.S. application Ser. No. 17/693,434, filed on Mar. 14, 2022, which is pending. The prior U.S. application Ser. No. 17/693,434 claims the priority benefit of Japanese application serial no. 2021-040744, filed on Mar. 12, 2021. The entirety of the above-mentioned patent application is hereby incorporated by reference herein and made a part of this specification.

### FIELD OF THE INVENTION

The present invention relates to an integrated article of FRP with a metal material through adhesion and a method for producing the same. In particular, the present invention relates to an integrated article of FRP with a metal material through adhesion, in which a metal for a structural material with high strength and CFRP (Carbon Fiber Reinforced Plastic) as extraneous materials used for a structural body of an airplane, an automobile, etc., are joined together, and a method for producing the same.

### BACKGROUND OF THE INVENTION

More than ten years have passed since CFRP as an ultralight material with high strength has come to be used for a structural material for a main wing, etc., of a largescale passenger airplane. Fixing of a CFRP material employed here as a material for a main wing to a body made of a metal structural material is not by direct fixing, but fixing by a mechanical fastening method to a body using a fastening member made of an ultra-super duralumin (Al alloy A7075). While mechanical rigidity of CFRP provides mechanical strength comparative with a high strength metal, it is originally a plastic born by carbon fiber (referred to as “CF” below). Due to this, in such a case as of fastened structure combined by a bolt-nut with a through-hole formed on the CFRP, CFRP will be easily broken when the nut is fastened too much. Special bolt-nut structure is proposed for preventing this.

CFRP material is a fiber reinforced material using CF with a thermosetting epoxy resin as a matrix resin, enabling adhesion with a metal member by use of an epoxy adhesive. However, a conventional rivet combining method using multitude of rivets made of Ti-alloy has been actually employed for large scale passenger aircraft, etc. As seen from the fact that a fastening method by a bolt-nut is not employed for a case of CFRP material with a metal material, there are many unsolved problems in a fastening method by adhesive. As for mechanical assembly of metal materials with high strength each other, fastening method by rivet is fully accomplished as assembling method with its career over a half century. However, if a joining assembly method using adhesive were made practical for an aircraft, this method could give a dedication in more easily lightening of structure of the body. In particular, if fastening of a wing made of CFRP material with a main central structure in the body made of metal material with high strength using adhesive could be made practical, it will be possible to apply the technique not only for a large-scale passenger aircraft, or, other aircrafts as a small-scale airplane, a military plane, high speed drone, etc., but also for a structural assembly such as an automobile for which lightening of the body is required.

### [Problems of Adhesive Method]

At present, thread structure are used in most cases of securing of assembly in a structure such as machinery, building, etc. That is, assembly method using adhesive for adhesion between parts is a rare securing method., as seen from whole machine industry. At present, structures by adhesive are partly employed in assembly of a body of a passenger aircraft. That is, as for securing of a rib structure made of an Al-alloy A7075 (ultra-super duralumin) with a hull sheet member made of an Al-alloy A2024A (super duralumin), joining by adhesive is used as an ordinary structure of a body of a passenger aircraft. While, for assembling this part, rivets were used and then screws or resistance welding were used in the past, method by adhesion is steadily used at present as it provides most light weight and high reliability. To say adversely, there is almost no case of employing structure by adhesion for assembling an important part other than in aircraft producing industry. Also, to say in another view, securing method by adhesion is used only joining metal members of a same kind. That is, the example mentioned above is a joined article of ultra-super duralumin with super duralumin, being a joined article of Al-alloys for each other.

Why an article by adhesion of CFRP material with an Al-alloy A7075 is not employed for a basic structure of an aircraft? As a conclusion, it is so because adhesive cannot bear due to large difference in thermal expansion rate between the members. Even if one-component epoxy adhesive taken as one having most strong adhesive ability among adhesives at present were used, it would provide adhesive ability of merely two-third thereof. Even if two-component epoxy adhesive enabling application of adhesion at an ordinary temperature were used, it would be similar. When this structure by adhesion is employed in an aircraft, used in a stratosphere in a tropical area, under a large temperature difference, such as from −50° C. to +150° C., the adhesive at the portion of adhesion will be broken due to difference of thermal expansion. Here, the inventor of the presented invention is also an inventor of “NAT (Nano adhesion technology)” explained later. That is, NAT means an adhesion technology by adhesive presented by the present inventor and adhesive used here is an epoxy adhesive. “NAT treatment” (chemical treatment of metal surface, specific ones thereof being explained later regarding experiment examples, etc.) explained later means a surface treatment method conducted on various metal materials so as to exhibit excellent ability of adhesion.

Further, with an article as a pair (test piece) shown in FIG. 1 formed by adhesion of same CFRP pieces using an epoxy adhesive, shear adhesion strength was measured. As the result of this measurement, even for a paired article by adhesion that was formed by adhesion for an optimum adhesion face to be cured using an epoxy adhesive having a high adhesion strength, its shear adhesion strength is 40 MPa in average or 55 to 60 MPa at highest. As seen for the trace of adhesion face of the broken test piece exhibiting the highest value, CF beard (broken CF) was observed. Breakdown of this test piece did not occur between the surface of CFRP piece and the surface of the cured adhesive, but, as revealed, occurred between the surface of CF and the matrix resin of CFRP. In short, for a newest CF (with tensile breaking strength of about 6 GPa) having circular fiber cross section and smooth fiber lateral surface, adhesion strength between the surface of CF and the thermosetting epoxy resin as a matrix resin is about 40 MPa. Here, cross section of CF is strictly of an ellipse form, rhombus form, a gourd form, etc., and there is also an old type CF (with tensile breaking strength of 3 GPa) in which lateral surface has lateral muscles or irregularities somewhere. Due to this, adhesion strength between the surface of CF and the thermosetting epoxy resin as a matrix resin is about 40 MPa. While apparent adhesion strength by calculation exhibits about 55 to 60 MPa, it is calculated taking these modified cross section forms of CF as a circular form, so to say, being an apparent adhesion strength. Then, in a case such that direct adhesion of a metal material with surface subjected to chemical treatment and a CFRP material is conducted and thus formed pair (a test piece) as shown in FIG. 1 is subjected to a tensile test in a state without difference in coefficient of linear expansion, there is no case that the breakdown face is near to a surface on the metal side but breakdown occurs necessarily near the interface between CF on the CFRP side and the matrix resin (see Patent Document 1).

As a consequence, it has no technical meaning to conduct study for development of raising adhesive strength in use of an epoxy adhesive to 60 MPa or higher with improvement of chemical treatment method for optimizing surface configuration, in order to improving adhesion strength corresponding to various metal materials, because adhesion strength between a CFRP material and a cured article of epoxy adhesive is less than 40 MPa, or 55 to 60 MPa. In particular in use for an aircraft, in which CFRP with newest CF having a high tensile breaking strength of 6 GPa, there is no meaning to try for improving chemical treatment method of metal surface to raise adhesive strength with an epoxy adhesive to 40 MPa or higher

### PRIOR ART DOCUMENTS

### Patent Documents

[Patent Document 1] JP, Published Patent Application No. 2011-073191
[Patent Document 2] JP, Patent Application No. 2020-018513
[Patent Document 3] WO2004/041532
[Patent Document 4] WO2012/070654
[Patent Document 5] WO2008/081933
[Patent Document 6] WO2008/078714
[Patent Document 7] WO2009/011398
[Patent Document 8] WO2008/114669
[Patent Document 9] WO2008/133096
[Patent Document 10] WO2008/133296
[Patent Document 11] WO2008/133030
[Patent Document 12] WO2008/146833
[Patent Document 13] JP, Published Patent Application No. 2018-111277
[Patent Document 14] JP, Published Patent Application No. 2011-006544
[Patent Document 15] JP, Published Patent Application No. 2016-150547

### Non-Patent Documents

[Non-patent Documents 1]
Nikkei-monozukuri (fabrication facility), Document of technology fair of machine elements “Multilayer composite of aluminum and CFRP with high specific strength” (developed by co-working of Taiseiplas Co. Ltd and Toray Co. Ltd), Jun. 24, 2009

### SUMMARY OF THE INVENTION

### Problems to be Solved by the Invention

In order to solve the problems mentioned above, the present invention attains the following objects.

It is an object of the present invention to provide an integrated article of FRP with a metal material through adhesion having highest strength of adhesion between high strength metal and CFRP in which there is a large difference in thermal expansion coefficients, and a method for producing the same.

It is another object of the present invention to provide an integrated article of FRP with a metal material that enables a structural article to have lighter weight, and a method for producing the same.

### Means for Solving the Problem

An integrated article of FRP joined by adhesion with a metal material according to the present invention 1 is one formed by laminating:
a plate material of FRP prepared by laminating CFRP prepregs having carbon fiber aligned in uni-direction so as to align direction of the carbon fiber, and
a high strength Al alloy material joined by adhesion with the plate material of FRP at the plate face or side face thereof to form an integrated object;
wherein the adhesive is epoxy resin adhesive and thickness of adhesive cured after adhesion is 0.3 mm or more.

An integrated article of FRP joined by adhesion with a metal material according to the present invention 2 is one formed by laminating:
a plate material of FRP prepared by laminating CFRP prepregs or CFRTP prepregs having carbon fiber aligned in uni-direction so as to align direction of the carbon fiber,
a metal sheet with a thickness of 0.2 to 1.0 mm having one face thereof secured to the plate material of FRP and the other face having been subjected to chemical treatment, and
a high strength Al alloy material joined by adhesion with the metal sheet at the other face thereof
   to form an integrated object;
wherein the adhesive is epoxy resin adhesive and thickness of adhesive cured after adhesion is 0.3 mm or more.

An integrated article of FRP joined by adhesion with a metal material according to the present invention 3 is one formed by laminating:
a plate material of FRP prepared by laminating CFRP prepregs having carbon fiber aligned in uni-direction so as to cause the carbon fiber to cross each other or by laminating CFRP prepregs having woven cloth of carbon fiber, and
a Ti alloy material joined by adhesion with the plate material of FRP at the plate face or side face thereof
   to form an integrated object;
wherein the adhesive is epoxy resin adhesive and thickness of adhesive cured after adhesion is 0.3 mm or more.

An integrated article of FRP joined by adhesion with a metal material according to the present invention 4 is one formed by laminating:
a plate material of FRP prepared by laminating CFRP prepregs or CFRTP prepregs having carbon fiber aligned in uni-direction so as to align direction of the carbon fiber or by laminating CFRP or CFRTP prepregs prepregs having woven cloth of carbon fiber,
a metal sheet with a thickness of 0.2 to 1.0 mm having one face thereof secured to the plate material of FRP and the other face having been subjected to chemical treatment, and
a Ti alloy material joined by adhesion with the metal sheet at the other face thereof;
   wherein the adhesive is epoxy resin adhesive and thickness of adhesive cured after adhesion is 0.3 mm or more.

An integrated article of FRP joined by adhesion with a metal material according to the present invention 5 is one formed by laminating:
a plate material of FRP prepared by laminating CFRP prepregs having carbon fiber aligned in uni-direction and GFRP prepregs having glass fiber aligned in uni-direction crossing the carbon fiber,
a Ti alloy material joined by adhesion with the plate material of FRP at the plate face or side face thereof
   to form an integrated object;
wherein the adhesive is epoxy resin adhesive and thickness of adhesive cured after adhesion is 0.3 mm or more.

An integrated article of FRP joined by adhesion with a metal material according to the present invention 6 is one formed by laminating:
a plate material of FRP prepared by laminating CFRP prepregs having carbon fiber aligned in uni-direction and GFRP prepregs having glass fiber aligned in uni-direction crossing the carbon fiber,
a metal sheet with a thickness of 0.2 to 1.0 mm having one face thereof secured to the plate material of FRP and the other face having been subjected to chemical treatment, and
a Ti alloy material joined by adhesion with the metal sheet at the other face thereof to form an integrated object;
wherein the adhesive is epoxy resin adhesive and thickness of adhesive cured after adhesion is 0.3 mm or more.

An integrated article of FRP joined by adhesion with a metal material according to the present invention 7 is one, in any one of the present inventions 1 to 6, thickness of the metal sheet is 0.3 to 2.0 mm.

An integrated article of FRP joined by adhesion with a metal material according to the present invention 8 is one, in any one of the present inventions 2, 4 and 6, the metal sheet is of a kind selected from Al alloy A5052, Al alloy A5083 and Al alloy A6061.

An integrated article of FRP joined by adhesion with a metal material according to the present invention 9 is one, in any one of the present inventions 3, 4 and 6, the angle of crossing is 90 degrees.

A method for producing an integrated article of FRP joined by adhesion with a metal material according to the present invention 10 is one for producing an integrated article in any one of the present inventions 1 to 6, the method comprising:
a step of forming a surrounding wall by inserting the metal material or the metal sheet with the surface thereof having been subjected to chemical treatment into a metallic mold for joining by injection molding and forming a surrounding wall that can retain liquid with a height of 0.3 to 2.0 mm by injection molding,
a step of filling adhesive by filling the surrounding wall on the metal material or metal sheet with epoxy resin adhesive before curing,
a step of painting by painting the epoxy resin adhesive before curing onto a surface of one selected from the plate of FRP, the metal material and the metal sheet,
a step of joining by pressing surrounding wall filled with the epoxy resin adhesive before curing onto the surface,
a step of curing adhesive by heating the joined article along with the epoxy resin adhesive before curing to cause the epoxy resin adhesive to be cured.

A method for producing an integrated article of FRP joined by adhesion with a metal material according to the present invention 11 is one, in the present invention 10, the method further comprises a step of degassing of gas in the epoxy resin adhesive before curing by repeated operation of decompressing and returning to an ordinary pressure for the epoxy resin adhesive before curing, after the step of filling with adhesive and the step of painting adhesive.

Each element composing the present invention will be explained below regarding technical background and its technical meaning.

### FRP (Fiber Reinforced Plastic) Composing the Present Invention

### [1-1] CFRP (Carbon Fiber Reinforced Plastics)

Various materials composing the present will be explained about essence thereof. While it is referred to as CFRP (carbon fiber reinforced plastics), it is strictly carbon fiber reinforced thermoset plastic. CFRP actually used in the present invention is one in which epoxy resin is used as the thermoset plastic. Further to say, plastic used in CFRP is also called as matrix resin, containing a so-called generic type of a substantially same constitution as one component epoxy adhesive, in which powder of dicyandiamide by about 10% is mixed in epoxy resin and a heat-resistant type based on a substantially same theory as two component epoxy resin adhesive consisting of an equivalent amount mixture of epoxy resin and aromatic diamine.

With heat resistance of a generic type, it is about 100° C. with a low heat resistance of cured matrix resin or 150 to 160° C. with a high heat resistance of cured matrix resin, and thus, resin portion within CFRP softens to become easily transformed under external force. On the other hand, with a heat-resistant type, while it is similar to two component epoxy resin in theory of curing, it is merely similar in that resin curing is created alternating copolypositant reaction, thus its complete curing temperature is higher than that of a generic type and heat-resistance is about 200° C. While both of a generic type and a heat-resistant type are used for production of a newest passenger aircraft, it is considered that CFRP of a heat-resistant type is used for a portion of a main wing near to an engine.

Therefore, with the present invention that aims to make joining so as to withstand thermal impact, cured adhesive has no valuable meaning without correspondent heat-resistance. As a heat-resistant epoxy adhesive the present inventor found in a market, there is such as “EW2040” made by Three M Japan Co. Ltd. (Main company in Tokyo, Japan) and sold as one component epoxy adhesive, which exhibits shear joining strength of about 35 MPa under 150° C., while composition provided by the present inventor exhibits about 42 MPa under 150° C. (see Patent Document 14). Thus, it is understood that the present invention should not be used in a structure by adhesion of CFRP and CFRTP used as a portion exposed to a high temperature of 160° C. or more. Of course, this problem is solved by replacing resin composition of epoxy adhesive with a heat-resistant type of thermosetting epoxy resin composition. However, the adhesive itself is a solid or powder at an ordinary temperature in this case, and manner of dealing with it becomes quite different. From these, another invention for improvement becomes necessary.

### [1-2] CFRTP (Carbon Fiber Reinforced Thermoplastics)

In the next, CFRTP will be explained. CFRTP (carbon fiber reinforced thermoplastics) is, as literal one, in which its matrix resin is a thermoplastic resin. Its resin composition is merely thermoplastic, and one with resin composition of thermosetting resin becomes CFRP. As a substantial difference from CFRP, when a CFRTP material is placed under a high temperature, plastic working of transforming the material from a flat sheet form into a curved form, a twisted form, etc., under adjustment of temperature and strength of pressure, as matrix resin softens by heating. While it is difficult to change form of resin in a large extent with this plastic working, transformation in a small extent is possible by heating and adding pressure. To say clearly, by preparing a CFRTP material of a sheet form, placing it into a thermoforming metallic mold and then operating heat pressing machine slowly, it is possible to transform its form into a curved form of a wing, etc., providing a desired form. In this, the present inventor has not got information yet that CFRTP is practically used in an aircraft.

As sheet articles of CFRTP moldable with heat pressing, those using polyamide resin such as PA66, PPS, PEEK, etc., are already produced as prototypes of mass production, then search of utilization thereof began after about year of 2015, and it can be said that the situation continues to be so at present. In this, high price of petroleum disappeared due to urgent development of shale gas and shale oil in USA and tendency of surplus of petroleum is seen in spread of hybrid vehicles. Also, for aircrafts, merit of operating ones using CFRP lowered. As a matter important in a long range, influential power of world moving towards saving energy becomes lower than before, rather changing to motion of restraining consumption of coal or petroleum corresponding to problems of global circumstance. Such situation does not lead to motion of employing an aircraft using CFRP employed for airplane 787 of Boeing Company, US, thus speed of employing becomes slow. Further to say, development of replacing CFRP material with CFRTP article seems to be further slower.

With this replacing, it is only replacing CFRP with CFRTP and replacing GFRP with GFRTP and principle of operation is same. While producing method thereof must be changed, of course, the producing method can be understood easily, seeing joining technology by injection molding of NMT, new NMT, etc., and joining technology by adhesive of NAT disclosed by the present inventor. That is, basic technique of joining method of CFRTP with polyamide resin or PPS as a matrix resin with a metal material is disclosed in Patent Document 15, and articles with a matrix resin of PEEK, PAEK (polyaryletherketone resin), etc., having high heat-resistance and taken as an excellent material as CFRTP can be obtained using producing technology integrating the CFRTP of PEEK and a metal material adhesion method disclosed in the present invention and Patent Document 15, and utilizing joining technology by injection molding between PEEK resin and a metal material disclosed in Patent Document 13 or the like. Consequently, when CFRP or CFRTP is to be joined with a metal material in the present invention, it will be dealt with as a similar material, while joining method and materials to be joined are various.

[2] Metal material with high strength for structure

A high strength metal material used as an object of the present invention is an aluminum alloy. For this, there is Al alloy A7075 as a normalized one. As other species, not only duralumin materials such as Al alloys A2024, A2017, A2014, etc., but also stretched Al alloys A6061, A5083, A5052, etc., can be used. Further, as high strength metal materials other than Al alloys, Ti, α-β Ti-alloy, α Ti-alloy, β Ti-alloy can be used. A Ti material frequently used for an aircraft is 64 Ti alloy of α-β Ti-alloy.

### [3] Metal Sheet

Metal sheet of an integrated article of FRP and a metal material according to the present invention means mainly one joined to a surface of a plate of CFRP or CFRTP by adhesion, joining by injection molding, etc. The metal material is caused to adhere onto the CFRP plate or CFRTP plate via the metal sheet using epoxy adhesive. The metal sheet is of Al alloy A6061, for example, preferably of a thickness of about 0.5 mm. The reason is such that this Al alloy has high extensibility and thermal conductivity and high followability to heat shrinkage or elastic transformation under mechanical load of the CFRP plate or CFRTP plate. However, this metal sheet is not limited to Al alloy, but may be of steel, etc., as long as it has followability to heat shrinkage of the CFRP plate or CFRTP plate. Metal sheet such as of steel can be transformed under load, has high thermal conductivity under circumstance temperature, and has followability to heat shrinkage of the CFRP plate or CFRTP plate. In this, it is not followable and inner stress becomes high, if the metal sheet is thick. Thus, the metal sheet is preferable to be thin as possible, preferably of about 0.2 to 1.0 mm.

### [4] Epoxy Adhesive and its Cured Layer

Adhesive of an integrated article of FRP with a metal material according to the present invention is epoxy resin adhesive with a thickness of 0.3 mm or more of the adhesive layer cured after adhesion. The thickness cured adhesive layer is preferable to be 0.3 to 2.0 mm. The cured adhesive layer according to the present invention means an adhesive layer between a CFRP plate or CFRTP plate and a high strength Al alloy material or Ti alloy material, or between a metal sheet and a high strength Al alloy material or Ti alloy material. While this epoxy resin adhesive is preferable to be one component epoxy adhesive, it may be two component epoxy adhesive.

### [Basic Technical Philosophy of the Present Invention]

With the prerequisite mentioned above, technical matters explained regarding the following conditions (i) to (iv) are important and necessary to the integrated article FRP with metal material. As a conclusion, the following conditions (i) to (iv) are ones for optimum adhesion providing high mechanical strength by adhesion and durability to thermal shock. That is: condition (i) approximation of coefficient of linear expansion, condition (ii) approximation of coefficient of linear expansion in two directions in an adhesion face, condition (iii) making coefficient of expansion optimum by laminated structure of CFRP or metal material, and condition (iv) security of thickness of cured adhesive layer.

[Explanation of Each Condition (i) to (iv)]

For the condition (i) approximation of coefficient of linear expansion, it is preferable to approximate coefficient of linear expansion of adhesion face of CFRP material to 2.3×10⁻⁵K⁻¹ (this is a value of coefficient of linear expansion of Al alloy), in order to make direct adhesion of a CFRP material with an aluminum alloy material (A7075), for example, with high strength. For the condition (ii) approximation of coefficient of linear expansion in two directions in an adhesion face, in order to make direct adhesion of a CFRP material with a metal material with high strength in a two-dimensional face, it is preferable that coefficients in two directions (vertical to each other) in the adhesion face between both materials are near to each other as possible. For making direct adhesion of CFRP material with a metal material other than Al alloy with high strength, Ti alloy material is preferable, as its coefficient of linear expansion is of a near value. The reason for this such that one having lowest coefficient of linear expansion among practical metal materials is a Ti alloy material (0.8×10⁻⁵K⁻¹), the value of coefficient of linear expansion is near to CFRP material. For this, it is necessary for the adhesion face of Ti ally material with CFRP material to make coefficient of linear expansion uniform in the adhesion face, causing influence by direction of CF to decrease. To this, it is preferable to use a CFRP material in which CFRP prepregs using cloth-type CF or CFRP prepregs of CF of uni-direction type are laminated so as to intersect each other (at an angle of 90 degrees, etc.). Coefficient of linear expansion of the surface of this CFRP plate is about 0.2×10⁻⁵K⁻¹, being of rather near value.

Further to say, there is a new condition (iii) “making coefficient of expansion optimum by laminated structure of CFRP or metal material”, which can be also said to be a new problem proposed by the present invention. Technical meaning of this condition (iii) will be explained, referring to FIG. 7. FIG. 7 shows a structural view of a FRP plate of a long shape with a large width, which is formed as a composite, laminating CFRP prepregs and G(glass) FRP prepregs alternately each other. The uppermost portion of long shape FRP plate is a uni-direction type of parallel CFRP prepreg in which fibers are aligned parallel to x-axis. With a prepreg of a second order from upper side, while a portion at left side in FIG. 7 is a uni-direction type of parallel CFRP prepreg in which fibers are aligned parallel to x-axis, similar as the first layer, it comes to an end at a position shown by a dotted line. The portion on right side of the dotted line one replaced with a uni-direction type of parallel GFRP prepreg in which fibers are aligned parallel to y-axis. A layer of a third order from upper side is a CFRP prepreg in which fibers are aligned in the same direction as the first layer, and a layer in a fourth order from upper side is GFRP prepregs same as the second layer. In short, all of layers of odd number order are same CFRP prepreg as the first layer, all of layers of even number order are same GFRP prepregs as the second layer, and all the layers are laminated and cured in an autoclave to be an FRP.

With a FRP plate shown in FIG. 7 in which CFRP and GFRP are laminated, coefficient of linear expansion in a plate surface at an end portion (a portion on the right side of the dotted line) is about 0.1×10⁻⁵K⁻¹ same as of CF on lines parallel to x-axis and about 0.8×10⁻⁵K⁻¹ of GFRP on lines parallel to y-axis, as the second layer is GFRP. In short, by laminating layers of CFRP and GFRP as shown in FIG. 7, coefficient of linear expansion becomes 0.8×10⁻⁵K⁻¹ of GFRP in y-axis direction, which is near to that of Ti-alloy, making it possible to follow it. Consequently, a CFRP plate of a long shape with a large width as shown in FIG. 7 can follow to expansion and contraction, if Ti-alloy is joined by adhesion to a face of with large width at the end of the plate in a high strength. However, even in this face of adhesion, there is directionality of linear expansion to be 0.1×10⁻⁵K⁻¹ of CF in x-axis direction of the face of adhesion, even Ti-alloy cannot follow to thermal expansion and contraction with such situation. Then, condition (iv) security of thickness of cured adhesive layer, for absorbing difference of expansion and contraction in the two directions in the face of adhesion. That is, the condition (iii) making coefficient of expansion optimum by laminated structure of CFRP or metal material is not established only with condition (iii), but the condition (iv) security of thickness of cured adhesive layer is necessitated.

This condition (iii) making coefficient of expansion optimum by laminated structure of CFRP or metal material, while being analogous to the condition (ii), means matching coefficient of linear expansion in y-axis to that of Ti material by laminating layers of various material to form CFRP shown in FIG. 7. With this condition (iii), it is possible to make an end of FRP to equivalent to a metal as required for mechanical fastening, not only for joining strength, but also for expansion and contraction of face of adhesion. This corresponds to an occasion when a metal material is fixed only to an end of a structure, for example, to an occasion when a main wing with a large width of an aircraft is fixed to a body. In short, by using a structure in which various materials are laminated in combination such as a FRP plate shown in FIG. 7 for a main portion, a Ti alloy plate can be joined to the right end thereof to be an integrated article. FIG. 19 shows a fastened structure in which a sheet of Al alloy A6061 is joined by adhesion to right end of a FRP plate and a plate of Ti alloy material is joined by adhesion on the upper side thereof. This structure can be used as a structure for fastening a CFRP plate by bolt-nut with the plate of Ti alloy material. While a plate of Ti alloy and an Al alloy A6061 material easily subjected to expansion and contraction are laminated by adhesion, these intervene between a CFRP plate and a Ti alloy plate and absorb thermal expansion and contraction in both side. Further, as there is a wide area of adhesion between the CFRP plate and the plate of Al alloy material, such effect is created that weak strength of adhesion between the CFRP and metal material can be covered.

### [Indispensable Conditions of the Present Invention]

With adhesion of CFRP with a metal material, even if condition (i) approximation of coefficient of linear expansion, condition (ii) approximation of coefficient of linear expansion in two directions in an adhesion face, and condition (iii) making coefficient of expansion optimum by laminated structure of CFRP or metal material, mentioned above, are taken as a prerequisite, difference of expansion and contraction between the two cannot be absorbed. Then, further as a measure for absorbing this thermal expansion and contraction, condition (iv) security of thickness of cured adhesive layer becomes one for optimum one for adhesion to obtain mechanical strength and ability to endure thermal shock. Thus, thickness of a layer of cured adhesive between CFRP and a metal material is thickened to be of 0.3 to 1.0 mm. It is a prerequisite to use an adhesive having high heat resistance. Ordinally, one satisfying these conditions is a layer of cured epoxy resin adhesive. At last, as the present invention is not established with each of the condition (i), (ii) or (iii) alone, only following three combinations of the conditions are considered.
(1) adhesion method by condition (i) approximation of coefficient of linear expansion+condition (iv) security of thickness of cured adhesive layer,
(2) adhesion method by condition (ii) approximation of coefficient of linear expansion in two directions in an adhesion face+(iv) security of thickness of cured adhesive layer, and
(3) adhesion method by (iii) making coefficient of expansion optimum by laminated structure of CFRP or metal material+(iv) security of thickness of cured adhesive layer.

The present inventor judged that all of the conditions (i), (ii), (iii) and (iv) cannot be realized as they are in a productive manner for production of a body of an aircraft, etc. and developed quite another joining method by adhesion of CFRP with a metal material. This is one mitigating linear expansion among various materials by laminated structure (Patent Document 2). As a basic form of the structure by adhesion, an integrated composite is proposed such that: taking two kinds of materials having coefficient of linear expansion of 0.3×10⁵K¹ selected from a group of high strength materials of CFRP, 64 Ti alloy, SPCC, SUS430 steel, SUS304 steel, Al alloys containing A5083, A6061, various duralumin, etc., as “material A” and “material B”, a soft metal, for example, Al alloy A1050 is sandwiched between the material A and the material B and then those are joined by adhesion as a whole. A CFRP material is subjected to a treatment preliminarily for improving adhesion ability such as roughening surface by chemical treatment, and each of metal materials are subjected to NAT treatment as an excellent surface treatment, and then all of these are joined by adhesion with one component epoxy adhesive having heat resistance. This is a basic technique. The present inventor proposed an invention prior to the present in Patent Document 2 and named chemical treatment disclosed there as NAT, and information and knowledge regarding this with a long endeavor of development of applied techniques can be entered there as a whole.

However, a basic study for dedication to making an aircraft, etc., with extremely light weight is not said to have completed by joining by adhesion of CFRP with Al alloy A7075 disclosed in Patent Document 2 as an prior art, to say strictly. The present inventor has come to consider that further improvement is necessary in order to employ this joining by adhesion of CFRT with a metal material for specifically a newest passenger aircraft, etc., considering difference of coefficient of linear expansion between both materials. Then, the present inventor has come to reconsider whether there is another invention having a similar object other than one disclosed in Patent Document 2, or not. As a result, it has been found that a method of joining by adhesive explained below is preferably employed for making the conditions (i), (ii), (iii) and (iv) mentioned above used practically. This method of joining is not a joining technique using adhesive, but one the present inventor already acquired and provided, naming as “NMT (Nano Molding Technology)”, “New NMT (New Nano Molding Technology)”, etc. Using this joining method by injection molding, that is, joining a metal with a resin by injection molding, the basic philosophy of the present invention mentioned above can be realized as production technology. This will be explained later.

[Regarding Thickness of Adhesive Layer](Condition (iv))

As explained above, in order to integrate a CFRP material with a metal material containing duralumin material by adhesion, it is preferable generally to approximate coefficient of linear expansion of actual face of adhesion on the CFRP side to that of the metal material. In a case with CFRP prepregs disposed structurally and epoxy adhesive used, thickness thereof is optimum to be 0.3 mm or more, preferably to be a thickness of 0.3 mm to 2.0 mm, as a conclusion. Here, also in this case, if area of adhesion is too large, there is a risk of delamination at a circumferential portion of the face of adhesion to lessen the area of adhesion, as appeared with a test of thermal shock of several thousand cycles to which an integrated part is subjected. A countermeasure to this with the present invention is “condition (iii) making coefficient of expansion optimum by laminated structure of CFRP or metal material+condition (iv) security of thickness of cured adhesive layer” using a CFRP structure, as explained above. Also limit of these areas of adhesion can be confirmed by an experiment using test pieces conducted before production of a practical aircraft. Therefore, the present inventor presents the present invention, considering it as improving technology that should be added to Patent Document 2 as a prior art. In recent years, CFRP materials are used in many ways for a newest large scale passenger aircraft. CFRP material with extremely light weight and high strength is an optimum structural material for application to an aircraft. In a fixing structure of CFRP material as a material of a main wing employed here to a body made of a metal material, fastening members made of ultra-super duralumin (Al alloy A7075) is fixed to a body by a mechanical fastening method.

Fixing structure of this fastening member with a CFRP member as a material of a wing is secured by adhesion. Although easiest method for joining a wing made of CFRP with a body securely is method by adhesion, it cannot be used because of large difference coefficient of linear expansion between both materials. Due to this, rivet method using rivets made of Ti alloy with large size is employed as a joining-fixing of both materials in a newest large passenger aircraft mentioned above. In this, it is reported that expense for fuel becomes 80% compared with that of a conventional aircraft (a large passenger aircraft with a basic structure made of duralumin) and total expense for maintenance such as management of the body, exchange of rotten parts, etc., is lessened to a half and so on.

To this, in actual production of a newest large passenger aircraft, it took rather time to change conventional connecting structure by bolt-rivet to connecting structure of CFRP material-Ti alloy with a body of ultra-super duralumin, as a well-known matter. Specific situation of toil therefor is not made open. It is assumed that there is much difficulty in production of large rivets made of 64 Ti alloy with high precision, in forming holes for putting them in with precise form of the rivets, and in acquisition of mass production technique thereof. In practice, operation of forming a hole with high precision in a CFRP material using drill teeth with a high speed of rotation is not so easy as expected. While many technical books of mechanical working of CFRP material are published recently, only few firms execute actual operation, and know-how of actual operation is a secret as a matter of course.

That is, if forming of an totally integrated structure by adhesion of a CFRP material with a material of Al alloy A7075 or a CFRP material with a material of 64 Ti alloy using epoxy adhesive is accomplished, irrespectively of a direct or indirect manner, it is possible to produce a light weight aircraft using conventional technique for the other, and this structural article can be expected to be a structure having an all-weather performance. In short, what is found already regarding chemical surface treatment of a metal (NAT) as technology of joining by adhesive is such that joining strength of about 40 MPa is attained at highest for joining CFRP materials each other or joining a CFRP material with a metal material using one component epoxy adhesive. With a technique by adhesion joining hard metal material by adhesion each other, highest joining strength is about 60 MPa. It is also found that such ability of adhesion is of no problem for metal materials of Al alloy, pure copper, steel of SUS304, Ti and Ti alloy even under a condition of high temperature and high humidity. Therefore, it is considered that the totally integrated structure by adhesion is fully maintained if delamination of adhesion by deformation of surface layer of cured epoxy adhesive (ultrafine irregularities of cured resin touching a joined material), breaking of the ultrafine irregularities from a main portion, etc., does not occur. While the present invention is similar to the invention disclosed in Patent Document 2, containing these matters, it is also a problem to be solved to employ a totally joined structure by adhesion removing structural portions using rivets in joined portions with metal materials in a structure of an aircraft having CFRP material as a basic structural material, causing the structure to have light weight.

### [Regarding Directionality of Coefficient of Linear Expansion of CFRP Material]

As coefficient of linear expansion of a CFRP material is various according to direction in a different manner from a metal material as explained above, it is necessary to consider this at first. With a CFRP material, being of a plate type obtained by laminating cloth-type CFRP prepregs, or being of a plate type obtained by laminating uni-directional (bundle type) CFRP prepregs so as to cause directions of fibers to cross, coefficient of linear expansion in a face of plates is averaged to be about 0.2×10⁻⁵K⁻¹ for both types, measured in any direction. However, with a CFRP plate obtained by laminating uni-directional (bundle type) CFRP prepregs without changing direction of CF fibers, coefficient of linear expansion is about 0.1×10⁻⁵K⁻¹ when measured in the direction of fibers and is (5 to 7)×10⁻⁵K⁻¹ when measured in a face perpendicular to the direction of fibers, the latter being quite different from the former. Even though the larger value of this (5 to 7) is various according to density of fiber (containing ratio of fiber) within CFRP, it is further larger than in case of a metal material. This is so because the value is near to that of a plastic material. Further to say, for coefficient of linear expansion at a portion corresponding to sectional face of a plate of a CFRP material obtained by lamination with direction of fibers in uni-directional CFRP prepregs kept as they are, coefficient of linear expansion in a direction such that direction of reinforcing fiber is overlapped (direction of lamination) is large, which is easily understood by seeing it in a perspective view. That is, coefficient of linear expansion is (5 to 7)×10⁻⁵K⁻¹, a value near to that of resin itself, when measured in a vertical face. In a face of a plate of CFRP material, directions having quite different coefficients of linear expansion cross each other at an angle of 90 degrees.

Then, seeing a side face of the CFRP plate in this case, there is crossing of coefficient of linear expansion at an angle of 90 degrees here, and it is considered that directions of values of coefficient of linear expansion of (5 to 7)×10⁻⁵K⁻¹ and about 0.1×10⁻⁵K⁻¹ cross at an angle of 90 degrees. On the other such a case can be seen that, also with CFRP material obtained using cloth type CFRP prepregs shown in FIG. 5, lines of coefficients of linear expansion quite different from each other similarly cross each other. For example, in a side face and a sectional face, coefficients of linear expansion are about 0.2×10⁻⁵K⁻¹ in a direction parallel to face of lamination and (5 to 7)×10⁻⁵K⁻¹ in a direction perpendicular to a face of lamination. In short, lines of coefficients of linear expansion different from each other cross each other even in a same face, with such a CFRP material. Kinds of these CFRP prepregs and laminated articles thereof can be understood referring to FIGS. 3 to 7.

FIG. 3 shows a plate of CFRP with CF aligned in a uni-directional manner obtained by laminating uni-directional CFRP prepregs so as to have a same direction of fibers and then conducting treatment by heating it with vacuum-pressure treatment to cure resin. FIG. 4 is a structural view showing an example of structure of CFRP, for a plate of CFRP obtained by sequentially laminating uni-directional CFRP prepregs so as to cause directions of fibers to cross each other (rotation by an angle of 90 degrees) and then conducting treatment by heating it with vacuum-pressure treatment to cure resin. FIG. 5 is a structural view showing an example of a structure of a CFRP material, for a plate of CFRP obtained by laminating cloth type CFRP prepregs sand then conducting treatment by heating it with vacuum-pressure treatment to cure resin. FIG. 6 is a structural view showing a structure of a CFRP material consisting of those having various laminar structures of CF. A plate shown in FIG. 6 is obtained by sequentially laminating uni-directional CFRP prepregs so as to cause directions of fibers to cross each other at an angle of 90 degrees for a left side portion in the figure and laminating uni-directional CFRP prepregs so as to have a same direction of fibers for a right side portion and then conducting treatment by heating it with vacuum-pressure treatment to cure resin. The plate of CFRP shown in FIG. 6 is of uni-directional CFRP prepregs for its total length, being a same CFRP prepreg for the left side portion (of a same laminated structure as one shown in FIG. 4) and for a right side portion (of a same laminated structure as one shown in FIG. 3) with fibers in a lengthwise direction extending continuously in a left-right direction in FIG. 6.

A plate of CFRP shown in FIG. 7 is one in which CF and GF(glass fiber) are laminated in a portion. A left side portion in FIG. 7 is CFRP with CF laminated in one direction, and a right side portion is one with CF prepregs and GF prepregs laminated. This plate material is formed to have a different laminated structure only at its end as a structure for a mechanical fastening. With a right end portion thereof, FRP structure is changed to be of a special type for enabling joining it with a plate material of Al alloy (condition (iii)), and uni-directional CFRP prepregs extend as they are. For a portion of FRP having this special structure at the end, prepregs over a half of the length are laminated so as to cross each other, and a group of the other prepregs is of uni-directional G(glass)FRP prepreg. That is, with a special portion of FRP, CFRP prepregs and GFRP prepregs are laminated so as to cross alternately each other.

### (Modeling of Thickness of Adhesive)

Basic technical philosophy of the present invention is the condition (iv) security of thickness of cured adhesive layer. That is, for strength of an integrated article of CFRP joined with a metal material by adhesion, thickness of a layer of cured adhesive between CFRP and a metal material has important technical meaning in the present invention. This matter will be explained in detail below. At first, for a plate of CFRP with CF aligned in one direction (shown in FIG. 3), in either of upper face or side face, coefficient of linear expansion of CF of about 0.1×10⁻⁵K⁻¹ (in a direction of CF) and coefficient of linear expansion of epoxy resin of about 5×10⁻⁵K⁻¹ (in a direction perpendicular to CF) at a right angle in the face. As a simple average of both values of coefficient of linear expansion is 2.5×10⁻⁵K⁻¹, which can be said to be near to Al alloy A7075 of 2.3×10⁻⁵K⁻¹. Regarding technical meaning thereof, situation of a plate of CFRP joined with a plate of Al alloy A7075 via a adhesive layer was considered as “an integrated article by adhesion” (see a referential figure of FIG. 8), taking the form of cured adhesive (cured adhesive between the plate of CFRP and metal material) composing the face of adhesion as a square of 50 mm having an area of 25 cm² (see FIGS. 9(a) to 9(c)).

This adhesive is one component epoxy adhesive “EW2040” having a curing temperature of 150° C. Such case is considered that form of cured adhesive of the integrated article by adhesion having cured at 150° C. is a square of 50 mm with a thickness of 1 mm and of upper face and lower face are of a quite same dimension, as shown in FIGS. 9(a) to 9(c). This comes to be reduced when cooled by −200° C. to −50° C. With this reduction, each side of the square of 50 mm is reduced by 0.23 mm (2.3×10⁻⁵K^{-1×200}° C.×50 mm) to 49.77 mm on the side of Al alloy (upper side in the figure). In contrast to this, as CFRP has directionality, side of the square reduced by 0.01 mm (0.1×10⁻⁵K^{-1×200}° C.×50 mm) to 49.99 mm and side of the square reduced by 0.05 mm (5×10⁻⁵K^{-1×200}° C.×50 mm) to 49.5 mm coexist (under side in the figure), thus the square is deformed to a rectangle on the side of CFRP (see FIG. 9(b)).

FIGS. 9(a) to 9(c) show conceptionally form of cured adhesive layer changing according to circumstance temperature. In short, for difference in side length, the form of cured adhesive layer on Al alloy side becomes one in which each of four sides is reduced equally by 0.23 mm, and the form on CFRP side becomes a rectangle having two different lengths of one side reduced by 0.01 mm and another side reduced by 0.50 mm. In a case where thickness of layer of cured adhesive is 1 mm, when a sheet form article having a dimension of 50 mm×50 mm×1 mm (a square shaped three-dimensional thin object) at a temperature of 150° C. is transformed to an object of trapezoid form at another temperature of −50° C. (FIG. 9(c)). Further to say, as this cured epoxy adhesive is formed object of resin without reinforcing fiber, coefficient of linear expansion peculiar to the resin is 7 to 8×10⁵K⁻¹. Original cured epoxy adhesive cured at of 150° C. is cooled to −50° C., that is, cooling by 200° C. Consequently, it is assumed that every side is exactly reduced to have a form of thickness of 1 mm with an intermediate concave portion as shown (FIG. 9(b)). However, regarding consideration of transformation by heating and cooling, it is considered for a model of soft nature of cured epoxy adhesive having a thin thickness that it may be simplified more. From this, in a case of a cured epoxy resin in a situation constrained by a CFRP material and a material of Al alloy A7075 at upper and lower faces with a high joining strength by adhesion, the transformed shape is considered to be one shown totally in straight lines in FIG. 9(c), that is, near to a rectangular frustum shape.

Anyway, in a case a plate model of cured adhesive kept to be generally as a plate shape by a CFRP material and a material of Al alloy 7075, the situation can be simplified by assuming that the cured adhesive has a form shown in 9(c) in which length of each side can be easily understood. In short, a sheet layer of cured adhesive with a thickness of 1 mm is a sheet of thermosetting resin having somewhat soft nature without rigidity compared with a CFRP material and a material of Al alloy A7075. Due to this, the layer of cured adhesive expands or contracts with its upper face and lower face trailed by the CFRP material and the material of Al alloy 7075 individually. In this, as apparent with a result of experiment, the cured adhesive is not a rubber type, though of a soft nature, and delamination may begin to occur in a face of adhesion when it is much deformed with thermal stress. The strength of adhesion is weak particularly on the side adhering to the CFRP material, such lamination occurs in any of four corners under influence of heat in directions of four faces.

Considering the deformed sheet of thermosetting resin shown in FIG. 9(c), it is understood that this delamination occurs due to a situation such that inner stress is generated at portions of four corners of the resin under such deformation exceeding the strength of adhesion with CFRP portion (while this strength of adhesion is 40 at an ordinary temperature, it becomes higher at a lower temperature and lower at a higher temperature). Here, actual delamination is assumed to occur at a time of a low temperature when it is subjected to thermal shock with high temperature and low temperature added. In a case of an aircraft under an actual natural circumstance, temperature in circumstance changes to be −50° C. in stratosphere, 30° C. at an airport, or even 100° C. at an airport in a tropical area, for example. If such severe thermal shocks are repeated for several hundred times, even with a composite having endured severe change of form anyway, breakdown by delamination is assumed to begin at portions of CF and matrix resin near to four corners of cured adhesive subjected to heat from four faces. As explained above, with coefficient of linear expansion in a face of a plate material of CFRP, two of about 0.1×10⁻⁵K⁻¹ and about 5×10⁻⁵K⁻¹ coexist, a simple average of these being 2.5×10⁻⁵K⁻¹. This value of a simple average can be said to be a coefficient of linear expansion of Al alloy A7075 having a value of 2.3×10⁻⁵K⁻¹, thus this simple view caused the present inventor to be optimistic.

That is, this model of a sheet object made of thermosetting resin is considered basically taking it not as a rigid one but of a soft object, so that there is in first no meaning in consideration with a prerequisite of the thickness of adhesive layer as not being zero but being 1 mm. A problem in a case of consideration of a model, when this sheet object is a little hard type of soft one, is in selectively deciding the sheet article to be one like hard rubber, like a soft metal such as lead, pure aluminum, etc., or like thermoplastic resin having soft nature such as LDPE (polyethylene of a low molecular weight). Assuming that the sheet article is like a soft metal such as lead, pure aluminum, etc., it is deformed according to coefficient of linear expansion creating a large deformation in x axis direction and a small deformation in y axis direction with changing temperature. Then, in a case where unequal deformation is crated only in the lower face of the sheet article and any side of the sheet material is deformed equally in the upper face of the sheet article, if change of area is same after all for the lower face and the upper face, same change should be created for length in z axis direction (thickness) and coefficient of volume change of the sheet article should have a determined value. Such thermal deformation is represented by coefficient of volume expansion. At first, simply from the fact that averaged value of two coefficients of linear expansion on the side of CFRP and coefficient of linear expansion on the side of Al alloy are of a well near value, without detailed calculation for each of x axis, y axis and z axis, average value, it was assumed that the sheet article sandwiched between the CFRP and the Al alloy will not be broken even under severe temperature change or thermal shock, if the sheet article is a material depending on coefficient of volume expansion. It is sure that, when a lead plate has been beaten, a concave is formed there and thickness increases for its amount at another portion. When, calculating this change of form, view of form shown in FIGS. 9(a) to 9(c) has been obtained, this gave a conviction to be a right result.

It is because the sheet article is not of such a material that is not broken by grasping change of volume according to temperature, even if form changes a little as for liquid, lead, etc. Here, used adhesive is one component epoxy adhesive having high heat resistance. This adhesive contains standard epoxy resin having two epoxy groups and additionally multi-functional epoxy resin having more than two epoxy resin. Therefore, the sheet article of resin formed to be cured is of a high molecule as one gigantic three-dimensional molecule having innumerable bridging portion. Thus, its complying ability is not such as a soft metal depending only on coefficient of volume expansion at all and, when the sheet article is transformed by an extremely large amount, delamination occurs at first at a portion on the side of CFRP having a weak strength of adhesion and most distant from the center of the face of adhesion, that is, at four corners thereof, in case of a square or rectangular form, and after then face of adhesion is reduced gradually with strength of adhesion weakened correspondingly. In order to confirm whether consideration by a model of cured adhesive layer explained above is right or not, the following experiment was conducted. In this, test pieces formed by adhesion with high strength (shown in FIG. 8) was prepared, as a formed object, that is assumed to clear a test by thermal shock of −50° C./+150° C. for three thousand cycles.

That is, in a case of a test piece shown in FIG. 8, the face of adhesion (cured layer of adhesin) is of 25 mm×25 mm with a thickness of 1 mm (see FIG. 10(a)). With the test piece heated or cooled, it becomes to have a form shown in FIG. 10(a) at a temperature of +150° C. when the adhesive is cured, and a form shown in FIG. 10(b) at a temperature of −50° C. Form in two side faces when cooled to −50° C. is shown in the right view of FIG. 10(b), calculated for a triangle with a right angle. While a long side of this triangle is 1.0023 mm, this means that expansion by 0.0023 mm+0.0015 mm occurred at for corner positions, taking a vertical length of this face as 1 mm at the center portion. The expansion strain is 0.38%, of a small value as a coefficient forcibly expanded by heat, so with the coefficient of strain, the cured layer of epoxy adhesive endures a test by thermal shock of −50° C./+150° C. for three thousand cycles. As a supposition by this model of form, it is considered that practical use will be possible, if this coefficient of expansion is lower than 1%. Thus, it was decided to prepare a prototype article and conduct a test by thermal shock for certification.

The cured layer of adhesive shown in FIGS. 10(a) and 10(b) in a model of 25 mm×25 mm for area of adhesion with a thickness of 1 mm is considered to afford a margin to thermal shock. Then, such a case of a thin layer of cured adhesive shown in Fog. 11 was studied that area of adhesion is 25 mm×25 mm and thickness of adhesion is 0.5 mm. Two side views for ones after thermal deformation are shown in the right side of FIGS. 11(a) and 11(b). As it is deformation to a trapezoid, its end portion is shown as a triangle having a right angle. The long side of the triangle expands to 0.50453 mm by calculation at a temperature of 200° C. This value shows that, in a case of vertical length of this face being 0.5 mm at the center portion of the face, length of hypotenuse is 0.50453 mm by calculation at four corners of the sheet and the hypotenuse at a temperature of +150° C. expands by 0.00302 mm with a temperature difference of 200° C., and its strain of expansion is 1.5%. While this value of strain of expansion exceeds 1%, it is considered to be a limit for use considered from mechanical strength of the cured layer of adhesive. Thus, it was decided to confirm whether consideration with a model mentioned above is suitable or not, causing it to be subjected to thermal shock test.

(What Kind of Thermophysical Property has a Formed Object of Resin as a Cured Object of Adhesive “EW2040”, as a Shaped Object Shown in FIGS. 11(a) and 11(b))

The cured layer of adhesive shown in FIGS. 11(a) and 11(b) is of a square shaped plate with 25 mm×25 mm×0.5 mm (thickness) under a step of adhesion at a temperature of 150° C. When a pair formed by adhesion (a test piece) shown in FIG. 8 for this is subjected to heating-cooling and cooled to −50° C., with change of temperature in both of upper face and lower face of the cured layer of adhesive, the cured layer of adhesive is deformed to a form shown in FIG. 11(b). Shapes of this deformed object is shown in the right side of FIG. 11(b). Regarding the present inventor thought that length at four vertical corner portions expands from the initial length of 0.5 mm by about 1.5% (0.91%+0.60%) and the secured layer of adhesion in such a situation will not be broken. While explanation regarding this is considered to be not clear logically, this will be explained in detail below.

### [Matrix Resin of CFRP]

It is necessary to make clear what one component epoxy adhesive having heat resistance is, and what kind of formed object of resin this cured object is. This means what characteristics physical property of formed resin has, while adhesive “EW2040” as explained above, one component epoxy adhesive with heat resistance disclosed by the present inventor in Patent Document 14 is solidified with thermal polymerization. Before this, it is necessary to consider also regarding matrix resin contained in a CFRP material and a cured object thereof. This is because for matrix resin usually used in CFRP is extremely similar to one component epoxy adhesive in its physical property. For a common composition, it can be said to contain an epoxy resin by about 90% and a dicyandiamide by about 10%. A CFRP prepreg is to be said in a situation such that the uncured matrix resin painted on bundles of CF, cloth of CF, etc., or one formed by inserting bundles of CF, cloth of CF, etc., across matrix resin and then removing surplus matrix resin. A CFRP prepreg is, to say with ratio of weight, consists of CF by about a half, and a long and sticky sheet object containing matrix resin by about half. A CFRP prepreg is produced this uncured matrix resin sandwiched between two sheets of polyethylene film disposed on upper and lower sides thereof, which is cut and surrounded with a cover, and then restored usually in a refrigerator to be used. The reason of restore it in a refrigerator is so as not to cause beginning of polymerizing reaction to occur by keeping it at an ordinary temperature over a term of several months or a year, as matrix resin is substantially same material as one component epoxy adhesive.

CFRP prepregs, being a sheet objects, are taken out of the refrigerator and cut. CFRP prepregs obtained by delaminating polyethylene film are laminated by placing one on another sequentially on a lower mold, an upper mold is placed on the laminated CFRP. After this, operation of lowering-raising of pressure in an autoclave, air between the layers of CFRP prepregs is extracted, and inner voids are smashed. After this the layers of CFRP are heated and caused to be polymerized and then cured. This operation of heating and polymerization is conducted in a similar manner to adhesion of a metal piece with another metal piece using one component epoxy adhesive and operation of adhesion by NAT explained above as a adhesion method of CFRP with a metal piece. With a plate of CFRP obtained in this operation, it is necessary to understand physical properties and characteristics of matrix resin contained therein. In short, coefficient of linear expansion of a CFRP material itself changes largely according to direction of aligned CF and, while it becomes (0.1 to 0.2)×10⁻⁵K⁻¹ in a direction, it becomes (4 to 5)×10⁻⁵K⁻¹ in a direction vertical thereto. Further to say, with resin as of a mere matrix resin without CF, being a formed article of resin having similarity with cured object only of one component epoxy resin, its coefficient of linear expansion, without directionality, is seemed to be (8 to 10)×10-5K⁻¹.

In short, cured object of matrix resin is same as a block of unreinforced thermoplastic resin or unreinforced thermosetting resin. Of course, while a temperature range involved in a cured object of matrix resin is limited to a range of about −50 to 80° C. from characteristics of resin, it is a range from a low temperature far apart from a high temperature range of a temperature of softening point to a range of ordinary temperature. All of the resins mentioned above have similar coefficient of linear expansion in such a range of temperature. This seems to be caused by such a factor that all of the resins are high molecules with main chains linked by methylene groups and the basis thereof consists in expansion-contraction of length according to changing temperature. It is natural that coefficient of linear expansion at this time has no directionality. It is reinforcing material such as GF, inorganic powder, reinforcing fiber, etc., mixed in resin by 20 to 30 weight % thereof that has a large influence on coefficient of linear expansion, strength, hardness, etc., thereof. In general, when such reinforcing materials are mixed in resin, coefficient of linear expansion thereof is lowered to be (2 to 5)×10⁻⁵K⁻¹, and coefficient of linear expansion of a resin with reinforcing fiber comes to have directionality, if formed article is one formed by injection molding. In short, taking a plate material of CFRP as an object of formed resin, coefficient of linear expansion originally having no directionality and having been (8 to 9)×10⁻⁵K⁻¹ becomes coefficient of linear expansion (0.1 to 0.2)×10⁻⁵K⁻¹, or (4 to 6)×10⁻⁵K⁻¹, under influence with CF added by near 50%. While it can be said that added materials have a large influence, it is also understood adversely that resin component is a soft material like a toufu (bean curd) ruled by added reinforcing fibers or reinforcing materials.

While prerequisite matters have been explained above, body of the present invention will be explained below. In what a cured object of “EW2040” shown in FIGS. 11(a) and 11(b) as explained above, that is, one component epoxy adhesive having heat resistance is different from a matrix resin for CFRP and a cured object thereof as explained above. Generally speaking, while, for composition of adhesive for securing heat resistance, epoxy resin composition contains star-type epoxy resin (not having epoxy groups of two, but having three or four thereof) by 10 to 20%, it can be also said that this is not present in matrix resin. However, the present invention has a point of view different from this. Recently, heat resistance is required for matrix resin in order to provide CFRP itself with heat resistance, thus star type epoxy resin is necessarily added at present. Therefore, there is substantially no difference from one component epoxy adhesive. Here, while adhesive contains added materials of inorganic powder, ultrafine powder of aluminum, etc., matrix resin does not contain such added materials. This is based on consideration such that physical property required to matrix resin is only heat resistant adhesiveness itself with carbon fibers and materials inhibiting this should not be added thereto. In short, a model having a form shown in FIGS. 11(a) and 11(b) is a plate material made of resin of a cured adhesive “EW2040”. This model has a mechanical property substantially same as matrix resin employed for CFRP, and has softness with which its basic form is not broken even with a change in a wide range from 0.1×10⁻⁵K⁻¹ of a CFRP material to (8 to 10)×10⁻⁵K¹ of a matrix resin itself.

Further to say, an original form of the formed article of resin shown in FIGS. 11(a) and 11(b) is of a form square shape at a temperature of 150° C. Due to this, in a case where this is cooled to −50° C. in a form having largest deformation, breaking occurs easily at corner portions thereof subjected to influence by heat from four sides. If breaking occurs, it must be at angular portions in four corners as portions having large difference of thermal expansion and portions of adhesion with contracted metal pieces. As the formed article of resin shown in FIGS. 11(a) and 11(b) is a cured object of adhesive, breaking of resin portion itself does not occur, with such tiny amount of change in form. However, how about strength of adhesion of this resin at a temperature of −50° C.? In fact, actual measurement of shear strength of adhesion at 150° C. was conducted only with the pair by NAT (a test piece shown in FIG. 1) as a pair of two joined pieces of Al alloy A7075 subjected to NAT chemical treatment using by adhesive “EW22040” as explained above. From this, the shear strength of adhesin was 30 to 35 MPa at 150° C., 60 MPa at 23° C., and 65 MP at 5° C. While the strength of adhesion is raised at a lower temperature, this is due to high hardness. Here, as temperature is lowered, tendency of rising strength of adhesion is lowered. Further, the present inventor did not conduct measurement of strength of adhesion, because there is no suitable test instrument.

Therefore, even if there is surely a supposition insisting softness regarding a plate material of cured one component epoxy adhesive shown by the present inventor, a doubt remains such that strength of adhesion with a metal material is not sufficient in some way. It is a fact that passenger aircraft having main wings made of CFRP materials fly over world, including stratosphere in north pole under a temperature of −65° C. In this, matrix resin in CFRP has no problem, because no delamination occurs in it, being restrained by bundles of CF, though it is apt to be shorter under such a temperature. With test by the present inventor, strength of adhesion between CF with matrix resin is about 40 MPa at 23° C. From this, while it may become 60 MPa at −65° C., force with which matrix resin itself is apt to expand-contract becomes inner stress even though restrained by CF. A cured object of one component epoxy adhesive, being basically same as matrix resin, delamination does not occur at a low temperature, even for portions of four corners in the structure by adhesion with a form shown in FIGS. 11(a) and 11(b).

### [Other Models of Layer of Cured Adhesive]

Models of layer of cured adhesive having forms other than one shown in FIGS. 11(a) and 11(b) as explained above are shown in FIGS. 12(a) to 12(c), 13(a) to 13(c) and 14(a) to 14(c), respectively. As explained above, a CFRP material prepared with uni-directional CF prepregs aligned in a same direction is of a type that has raised tensile strength in a direction of CF to a highest level. A CFRP material used more frequently than this is one formed by lamination of cloth type of CFRP prepregs. One having substantially same performance can be prepared by laminating uni-directional CFRP prepregs so as to cross at an angle of 45 degrees or at an angle 90 degrees for each other. Coefficient of linear expansion in a face of a plate of these CFRP is about 0.2×10⁻⁵K⁻¹. Similar calculation was conducted for a pair formed by adhesion of these CFRP plates with a 64 Ti alloy material having lowest coefficient among metal materials, being a light metal and not easily rusting (a pair of a CFRP plate with a 64 R\Ti alloy material). A model of a layer of cured adhesive at this time is shown in FIGS. 12(a) to 12(c). Here, coefficient of linear expansion of 64 Ti alloy is about 0.8×10⁻⁵K⁻¹. Further, calculation was conducted, taking area of adhesion of this model as 50 mm×50 mm and thickness of the layer of adhesive as 1.0 mm. FIG. 12 (a) shows a form at a temperature of +150° C. and FIG. 12(b) shows a form at a temperature of −50° C. FIG. 12(c) is a view of FIG. 12(b) seen in a direction of arrow A as a side view of the layer of cured adhesive. In this, FIG. 12(c), stretched length of diagonal of the small triangle is 1.00045 mm and strain thereof is 0.045%. In this, as each of four corner portions is a line of intersection of a side with another, exact strain ratio becomes 0.90%. This value of strain is small as in a level having no problem of breaking by thermal stress.

Similar calculation was conducted for a model with a layer of cured adhesive having a thickness of 0.5 mm. This is shown in FIGS. 13(a) to 13(c). FIG. 13(a) shows a form at a temperature of +150° C. and FIG. 13(b) shows a form at a temperature of −50° C. FIG. 13(c) is a view of FIG. 13(b) seen in a direction of arrow A as a side view of the layer of cured adhesive having a thickness of 0.5 mm. Here, length of diagonal of the small triangle is 0.5009 mm and length of contraction(strain) at a temperature of −50° C. becomes 0.18%. Also here, as each of four corner portions is a line of intersection of a side with another, exact strain ratio becomes 0.36%. With this strain ratio, it is assumed that it can endure a thermal shock sufficiently.

Therefore, similar calculation was conducted for model with area of adhesion of 100 mm×100 mm and layer of adhesive having a thickness of 0.5 mm. This is shown in FIGS. 14(a) and 14(b). FIG. 14 (a) shows a form at a temperature of +150° C. and FIG. 14(b) shows a form at a temperature of −50° C. A side view of the layer of cured adhesive is shown in the right side of FIG. 14(c). Here, length of diagonal of the small triangle is 0.50359 mm and stretched length thereof (strain) is 0.72%. In this, as each of four corner portions is a line of intersection of a side with another, exact strain ratio becomes 1.44%. While this value exceeds a strain ratio of 1% decided as a safe range, it is in a range having no problem for a practical use.

[Method of Adhesion of CFRP with a Metal Plate with Intervention of a Metal Sheet]

While there is a method of direct adhesion of CFRP with a metal plate, methods other than a method of direct adhesion will be explained here. Apart from the above consideration, one of important conditions in the present invention is strength of adhesion of a CFRP material with one component epoxy adhesive. As explained above, surface of same CFRP pieces was treated to be coarsened and then joining by adhesion using one component epoxy adhesive “EW2040” was conducted to prepare a pair formed by adhesion (a test piece) shown in FIG. 1. It was explained that shear strength of adhesion of this pair formed by adhesion of CFRP with a metal plate is about 40 MPa in a case where a new type of CF (with tensile strength of about 6 GPa) is used, and is about 60 MPa at highest in a case where a conventional type of CF (with tensile strength of about 3 GPa) is used. Such method of joining by adhesion of a CFRP material is called as a dry method, by which actual shear strength of adhesion is attained only to be about 80% thereof, depending on method of coarsening as preprocess and cleaning-drying after it. When “soakage treatment” (filling adhesive to a surface with ultrafine irregularities) is abbreviated, there is a case where only about 80% is attained. In short, a CFRP sheet with a metal sheet such as Al alloy A6061, etc., joined on a face for adhesion thereof by adhesion is prepared preliminarily, and another metal plate is joined the metal sheet by adhesion in a practical use. Thereby strength of adhesion becomes stable.

FIG. 19 shows an example of indirect joining of a CFRP plate with a plate of TI alloy via aa metal sheet. This example of joining is not a direct joining of a CFRP plate with a plate of Ti alloy, but a joining of a CFRP plate with a plate of Ti alloy via a sheet of Al alloy A6061. A method used for joining a metal sheet with a CFRP material is called as a wet method. With this method of adhesion, one component epoxy adhesive or matrix resin is painted on the uppermost portion of a CFRP prepreg, on which a metal sheet such as a sheet of Al alloy A6061 with a thickness of 0.5 mm having been subjected to NAT treatment as explained above is laminated, and then these are integrated in an autoclave in a similar manner as in producing CFRP.

By this method, with an area of adhesion of a CFRP portion with a metal sheet being wide and an area of adhesion of this sheet portion with a metal material having been subjected NAT treatment of a duralumin material, a 64 Ti alloy material, etc., being a half or less of the area of adhesion of a CFRP portion with a metal sheet, shear strength of adhesion between the CFRP material and the metal material of a duralumin material, a 64 Ti alloy material, etc., can be raised to 60 MPa, even though shear strength of adhesion between the CFRP portion and the metal sheet is 40 MPa at highest. In short, a suitable metal sheet that can follow to expansion-contraction of a CFRP material is joined to a CFRP plate material by adhesion and a metal plate desired to be joined with the CFRP material is joined by adhesion. This is a joining method by intervention of a metal sheet for joining a CFRP material with a metal plate by adhesion and, if joining by adhesion of all of these is conducted with a method by NAT presented by the present inventor, strength of adhesion of CFRP material itself will be stable and its final shear strength of adhesion can be about 60 MPa of a highest value.

[Thickness of Layer of Cured Adhesive of 0.3 to 2 mm]

For the model explained above, thickness of layer of cured adhesive is assumed to be 1.00 mm and 0.5 mm. While c5ured object of one component epoxy adhesive shown in FIGS. 11(a) and 11(b) is of 25 mm×25 mm×0.5 mm as explained above, a pair formed by adhesion (a test piece shown in FIG. 8) with a dimension of this cured object was prepared. As explained above, the pair formed by adhesion was placed in a test instrument of thermal shock of −50° C./+150° C. for three thousand cycles and certification was conducted by observing results thereof in the present invention. Here, thickness of layer of cured adhesive is more preferable to be as thin as possible. The reason of this is such that, even if a pair formed by adhesion (a composite of a metal with resin) endures thermal shock, it is preferable to have a small mechanical deformation even for a large thickness when used as a composite in an apparatus or the like. Thus, by making thickness of a layer of cured adhesive about 0.3 mm according the condition (iv) explained above, this can endure thermal shock, making adhesion easy. However, if the layer of cured adhesive is too thin, operation of adhesion is difficult as production technique. Considering meaning of thickness of about 3 mm, though not restricted to epoxy resin adhesive, when adhesive is cooled after over heated for curing thereof, curing of a portion of material to be joined by adhesion begins at instant. This thickness is about 0.2 mm, which is called a hull layer called so even also in injection molding. Similarly, also with layer of adhesive surrounding CF, this hull is about 0.1 mm. As a sum of these, a layer of cured layer of epoxy resin adhesive is formed. Basis of the thickness of the layer of cured adhesive to have a maximum value of 2.0 mm consists in such that it is preferable for deformation under load from outside to the integrated article to be smaller even though there is no problem in strength of adhesion with a too thick layer of adhesive, air is easily mixed in with a too thick layer of adhesive and mixed air cannot easily removed even with degassing. For such reason, thickness of a layer of cured epoxy resin adhesive is to be 0.3 mm or more, preferably to be of 0.3 to 2.0 mm. As this one component epoxy resin adhesive, it is not necessary to be a special one, but also “EW2040” with excellent heat resistance and commercially available can be used, or it may be one proposed in Patent Document 14 by the present inventor.

An adhesive exhibiting shear strength of adhesion at a temperature of 150° C. can be used for joining a metal material with another metal material each other. Here, condition for these adhesives curing completely is a temperature of 150° C. to 170° C., which causes operation of adhesion aiming to a thickness of about 0.5 mm, for example, to be difficult suddenly. On the other hand, curing at an ordinary temperature is possible basically with two component epoxy adhesive, and curing can be accomplished even for about a day, if a room for heating at a temperature of 50° C. or so in order to shorten time for curing. In this, strength of adhesion of two component epoxy adhesive at an ordinary temperature is generally low to be about two thirds of one component epoxy adhesive. Further, two component epoxy resin adhesive having heat resistance is not developed historically and there is no one commercially available as long as the inventor knows, because such was not required by markets. If technology of adhesion with intervention of a sheet comes to be practical as the present invention or prior invention disclosed in Patent Document 2, study and development improving two component epoxy adhesive to one having heat resistance seem to be advanced. Consequently, two component epoxy adhesive is not extruded in the present invention. Thickness of layer of adhesive in the present invention is 0.3 mm or more, preferably 0.3 to 2.0 mm, consideration regarding development of practical technique for securing this thickness is conducted below, with an example of commercially available one component epoxy adhesive “EW2040”.

With adhesion according to NAT theory as explained above, one component epoxy adhesive, having viscosity and being paste-like material an ordinary temperature is painted on a CFRP piece having been subjected to coarsening treatment and on a metal piece having been subjected to NAT treatment (surface treatment for adhesion), after which decompression vacuum treatment is conducted placing these in a desiccator. With this decompression vacuum treatment, air remaining in ultrafine irregularities formed on the surface of the CFRP material and the metal material, air solved in the adhesive, solvent of a low boiling point, etc., are removed. After the decompression vacuum, also such operation is necessary as returning to an ordinary pressure and pushing adhesive into trace of air removed from the above irregularities under an atmospheric pressure. After operation of painting such adhesive on the two materials, added adhesive is applied on either of the materials and then the designated thickness of adhesion is secured. Further, after the decompression/returning to an ordinary temperature in the desiccator, air is kept not to remain in the adhesive, then heating is conducted to 150° C. or higher cure adhesive. When temperature has risen to 70 to 90° C. with a first heating of the curing step, painted one component epoxy adhesive is changed to liquid having a low viscosity with urgent decrease in viscosity. After this, polymerization of adhesive as liquid having a low viscosity begins to be advanced after temperature has risen to 120° C. or higher. Therefore, it is necessary to establish a method of adhesion causing liquid having a low viscosity not to leak out of the place of curing adhesive.

### [Securing Thickness of Layer of Cured Adhesive and Sheet Type Adhesive, Etc.]

The present inventor purchased sheet type adhesive used commonly by aircraft makers, etc., in a market. This sheet type adhesive is nonwoven fabric of synthetic fiber of nylon fiber, etc., with one component epoxy adhesive soaked therein. In producing an aircraft, a step is well known that a body structure of the aircraft is formed by sheet materials made of Al alloy A2024 are joined by adhesion to rib structures made of Al alloy A 7075, and examples of using cut sheet type adhesive in place of paste like adhesive in a step of joining by adhesion. In the present invention, study was conducted whether such sheet type adhesive can be used. In the present invention, sheet type adhesive was used, not for forming a layer of cured adhesive as called in the present invention, but for simplifying painting step without painting adhesive repeatedly. Only by placing five sheets or so of such adhesive in an overlapped manner onto a surface for adhesion and simply pressing both materials to be joined by adhesion with crips, etc., it was expected that layer of adhesive having thickness of about 0.5 mm easily, and experiment was conducted. However, the adhesive was softened when heated, for a supposed cause of too strong compression at heating, and the sheet type adhesive flew out from the nonwoven fabric, thus it was confirmed that desired thickness cannot be formed with such a method of experiment.

A layer of adhesive having a desired thickness is not formed by pushing both materials with compression, unless resin fiber having a high melting temperature or natural fiber of silk, cotton, hemp, etc., is used as fiber for use as nonwoven fabric. In such a case that not nonwoven fabric but plain and rough cloth of natural fiber as sheet type adhesive is used it is supposed that there is a possibility of securing desired thickness of layer of adhesive. Here, sheet type adhesive with one component epoxy adhesive soaked in cloth material using hemp fiber, for example, is clearly a FRP prepreg of hemp. When natural fiber of silk, cotton, hemp, etc., are used in place of carbon fiber, natural fiber of silk, cotton, hemp, etc., a layer of cured adhesive itself containing natural fiber of silk, cotton, hemp, etc., has a certain coefficient of linear expansion. A reason of causing a layer of cured adhesive to have a thickness of 0.3 to 3 mm in the present invention consists in that these are soft materials without reinforcing fiber. A layer of cured adhesive itself containing natural fiber of silk, cotton, hemp, etc., is only of one having softness following with obedience even to coefficient of linear expansion of CFRP and Al alloy A7075 between which the layer of cured adhesive is sandwiched. From such, it was decided that it cannot be used in view of securing mechanical strength.

On the other hand, it is necessary for a layer of cured adhesive to have a determined thickness. Then, while such a measure is considered as mixing heat resistant plastic particles having diameter of 1 to 3 mm by a several weight % into one component epoxy resin not as fiber but as inner spacers and causing the adhesive to be cured to have thickness of 1 to 3 mm, such thickness could not be secured with this method. If thickness of layer of cured adhesive made thick as of a several mm, there is a possibility such that adhesive flow out from a portion of adhesion when the adhesive is changed to liquid with low viscosity due to rising temperature for curing by heating. Thus, with the present invention, a method for securing thickness of layer of cured adhesive certainly was developed. This is a method of intervening such ones as of spacers in a layer of adhesive and causing a wall of a pool to surround outer peripheral portions of the layer of adhesive for preventing liquidized adhesive by heating from flowing out, though detailed structure will be explained later.

### [Securing Thickness of Layer of Cured Adhesive]

As understood with above explanation of a model, it is necessary for a layer of cured adhesive of an integrated article of FRP with a metal material of the present invention to secure a determined thickness. In a case of actual epoxy adhesive, heating to a high tempered, which leads to lowering of viscosity thus it becomes difficult to secure thickness. A method for securing this thickness will be explained below. As a conclusion, this is a method of forming a closed spacer wall on the surface of a metal material so as to prevent liquidized adhesive from flowing out and entering adhesive within the wall to cure it. Specific example thereof are shown in FIGS. 15 to 18. That is, in order to form a spacer wall made of resin, surface treatment for joining by injection molding is conducted on a metal material side, and resin of “SGX120 (produced by Tousou Co. Ltd.: main company in Tokyo, Japan)”, etc., is injected onto the surface to form the wall. More effectively, NAT treatment (chemical treatment of surface) is conducted on a metal material side and a spacer wall is formed by injection molding on the surface of the metal. Then, it was assumed that operation of curing adhesive as mentioned above can conducted in a manner that epoxy adhesive is filled within the spacer wall and it is covered with a lid of CFRP material. A frame as exemplified in FIGS. 15 to 18 is formed as an outer frame of the spacer wall. Techniques of forming such a spacer wall by injection molding on a surface of a metal is well known in the art, so it is not explained in detail. In this, the present inventor presented previously “NMT” and “New NMT” as techniques of joining a metal with resin by injection molding (Patent Document 3 to 7).

A spacer wall is not related directly to strength adhesion between a CFRP and a metal, but is one for preventing adhesive liquidized by heating from flowing out. This technique of joining by injection molding may not be a special method or one forming it with resin, as special material. For example, it may be formed with paper clay. A technology of NAT of joining by adhesion using epoxy adhesive as a known art presented by the present inventor may be used preferably for forming a spacer wall intentionally from the first. This technology of NAT provides a measure for solving conditions including (i), (ii), (iii) and (iv) as explained above as a result (see [0024]). Further, this technology of NAT od joining by adhesion can be also in a case where CFRTP is used in place of CFRP or GFRP. It is considered that the present invention provides a technique dedicated sufficiently to practical use even for a aircraft, etc., with a somewhat small area adhesion.

### (About NAT as a Technology of Adhesion in a High Level)

The present inventor invented and presented technology for raising strength of adhesion to a high level named as NAT (Nano adhesion technology) as explained. This is not technology for causing adhesive itself to have high performance, but is related to a method of surface treatment of a metal piece, that is, an object to be joined by adhesion. As such, NAT is technology of joining by adhesion using adhesive for all kinds of metal as objects to be joined by adhesion, and NAT requires following five conditions for establishment thereof. Regarding metal pieces to be used, following three conditions are such necessitated, and a method of surface treatment for chemical treatment satisfying these three conditions is called as “NAT treatment” and presented. The treatment method is one satisfying all of the necessitated conditions:
(1) to make surface of a metal have a coarse face with irregularities of a period of 0.8 to 10 m,
(2) to cause the coarse surface to have ultrafine irregularities of a period of 5 to 300 nm thereon, and
(3) to cause the above surface having dual irregularities to consist of a thin hard ceramic layer of metal oxide, metal phosphate, etc.

Further, following two conditions are necessitated regarding kinds of adhesives and operation of adhesion:
(4) to employ one component adhesive with priority or select one having slow effect as curing agent without one component adhesive, and
(5) to include a step of “soaking” in operation of adhesion.

The above condition (4) requires for the adhesive to contact with a surface of a metal in a uncured state of molecules of a low molecular weight, and the condition (5) intends forcing the molecules of a low molecular weight to penetrate into the ultrafine concaves of face having ultrafine irregularities up to the bottom thereof. That is, to say simply one that NAT aims at, it is a clear statement of a simple theory such that: with surface configuration of a metal to be joined preferably of ultrafine irregularities of 5 to 100 nm order and a coarse face of micron order and with the face of ultrafine irregularities mentioned above being wide (large ratio of surface area to apparent area), highest strength of adhesion is acquired by painting adhesive in a state of a low molecular weight (having a low viscosity) and causing the adhesive to penetrate into the ultrafine irregularities up to the bottom of the concave, thus advancing afterward polymerization to cure the adhesive.

This NAT theory was certified for various metals (Patent Document 8 to 12). Further, while one component adhesive is preferable according to the condition (4), and the present inventor decided that one component epoxy adhesive is most useful for NAT. Thus, almost all of the above experiments for certification was conducted using one component epoxy adhesive. Actually, high strength of adhesion that NAT exhibited gave stimulus to many engineers. To say from examples, using one component epoxy adhesive available in market, as not a special one, shear strength of a pair joined by adhesion of same kinds having been subjected to NAT treatment was obtained to be about 55 to 70 MPa at a temperature of 23° C.

### (Situation of Development of NAT in Recent 10 Years)

Process of development of NAT will be explained simply. In a case where one component epoxy adhesive “EW2040” (produced by Three M Japan (main company in Tokyo, Japan)), shear strength of adhesion of 58 to 63 MPa (at 23° C.) was observed for a pair of metal pieces of a same kind joined by adhesion having been subjected to NAT treatment or improved NAT type surface treatment (surface treatment for conventional and improved NAT will be referred to as “NAT treatment” below), that is, to say roughly as there is dispersion, shear strength of adhesion of about 60 MPa was observed, it seemed that about 60 MPa is a maximum value for this adhesive.

### (Regarding Method for Measuring Strength of Adhesion in the Present Invention)

The method for measuring strength of adhesion in the present invention is different from a common method for measuring strength of adhesion. That is, shear strength of adhesion and tensile strength of adhesion in the present invention is not ones by method defined in JISK6849 and 6850. By a method defined conventionally in these public standards, exact shear strength of adhesion cannot be measured when strength of adhesion is so high as in the present invention. Further, for measurement of tensile strength of adhesion, it is difficult to obtain metal pieces having a form decided in the above methods. Especially, with a sheet metal material having a thickness of 0.4 to 3.0 mm, area for adhesion cannot be secured and exact measurement cannot be attained. In each of the inventions concerning NAT presented by the present invention (Patent Documents 8 to 12) and in the present invention, shear strength of adhesion was measured by a standard method using test pieces shown in FIG. 1. However, at a time when NAT technology concerning Al material (Patent Document 8) was developed, tensile strength of adhesion was measured for a pair joined by adhesion (a test piece) in such a form that two metal pieces having a dimension of 18 mm×4 mm×3 mm (thickness) are joined by adhesion at end faces each having a dimension of 4 mm×3 mm each other. After a several years after this, tensile strength of adhesion was measured for a pair joined by adhesion in such a form that two metal pieces having a dimension of 100 mm×25 mm×3 mm (thickness) are joined by adhesion at end faces each having a dimension of 4 mm×3 mm each other. Further, at recent, tensile strength of adhesion was measured for a pair joined by adhesion in such a form that two metal pieces having a dimension of 45 mm×18 mm×1.5 mm (thickness) are joined by adhesion at end faces each having a dimension of 18 mm×1.5 mm each other.

### (Regarding Technology of Joining by Injection Molding: NMT, New NMT)

NMT (Nano molding technology) and New NMT, being technology of joining by injection molding for forming a spacer wall, etc., mentioned above as referential technology, will be explained shortly. This technology consists in that chemical treatment of “NMT treatment”, “New NMT treatment”, etc., as surface treatment of a metal piece is conducted preliminarily at first, the metal piece is inserted into a mold for injection molding, and thermoplastic resin composition with high crystallinity for joining by injection molding with adjusted composition is injected to form an integrated article in which the metal piece and molded resin are joined with a high strength. There is a preferable method of surface treatment for each metal piece, and both of a technique of chemical treatment finding an optimum method through searching and improvement and a technique finding an optimum resin composition were key matters. These are substantially established for substantially all metals and metal alloys obtained as ones commercially available, and for kinds of resins to be injected of PBT resin, polyamide resin, PPS resin and PEEK resin. These matters are disclosed in Patent Documents 3 to 7.

As a mechanism creating high strength of joining by injection molding between a metal and resin, there is surface configuration of double or three folded complex face of irregularities with various periods containing ultrafine irregularities of period of several tens of nanometer on the side of a metal, joining by injection molding with resin composition advances easily in a case where amine molecules are adsorbed on the surface. From this, a treatment method that includes a chemical adsorption step of amine molecules in its surface treatment is refereed to as NMT treatment method, and a treatment method with which adsorbed molecules of amine is not contained in an object having been subjected to surface treatment is referred to as New NMT treatment method. Then, techniques of joining by injection molding acquired from these are referred to as NMT and New NMT, respectively. Actually, what amine molecules are chemically adsorbed on species of Al alloy, so that there are “NMT” and “New NMT” for Al alloy and “New NMT” can be used as a technique for all of the other metals.

The basis of NAT treatment method conducted for each kind of metal material with technology of joining by adhesion “NAT” presented explained above was New NMT treatment method itself acquired as a technique of joining by injection molding. The present inventor invented techniques of joining by injection molding NMT and New NMT at first, and invented a technique of joining by adhesion NAT in a horizontal expansion thereof. That is, while individual surface treatment methods acquired in a process of development for obtaining highest strength of joining by injection molding and highest strength of joining by adhesion are various slightly, all of these are analogous. Consequently, to say regarding the present invention, each NAT treatment method is analogous to New NMT method and NMT method, not only for Al alloy including duralumin material, but also for a Ti material, a Ti alloy material and general steel materials including stainless steel. In short, each kind of metal material having been subjected to an optimum NAT treatment can be used sufficiently in order to form a structure of a spacer wall in a step of adhesion, even though it does not provide highest strength of joining by injection molding.

### (Summing up)

The present invention has a same object as the prior invention (Patent Document 2), and is an improving invention for compensation thereof. That is, the present invention discloses that, as a technique of joining a CFRP material with a certain metal material directly, there is a method that enables direct adhesion taken as impossible in an ordinary manner to be possible by selecting laminated structure of CFRP materials or used CFRP prepregs and placing order therefor.

[Method for Producing an Integrated Article of FRP with a Metal Material]

Method for producing an integrated article of FRP with a metal material according to the present invention is as follows in general. A formed object of metal having been subjected to chemical treatment is fixed with its face to be joined by adhesion being in horizontal and one component epoxy adhesive is filled somewhat overly on the face to be joined by adhesion within a wall surrounding the face as a pool form. In the next, the formed object is entered into a large vacuum bag or large autoclave and operation of decompression-returning to a normal pressure is conducted with gas, etc., solved in the adhesive degassed. On the other hand, coarsening operation is conducted on a face to be joined by adhesion of a plate of CFRP or FRP, and then the plate is washed and dried for preparation to operation of adhesion. After this, one component epoxy adhesive is painted on the face to be joined by adhesion to be thin amount, and the plate is entered into a large desiccator or large autoclave and operation of decompression-returning to a normal pressure is conducted with gas, etc., solved in the adhesive degassed for preparation. This plate of CFRP with adhesive thereon is placed on the above formed object of metal fixed to a holder so as to be in a decided position, and then these are pressed a little to be fixed, after which these are placed in a hot air drier as it is at a temperature of 150° C. or more to cure adhesive.

Further, method for producing an integrated article of FRP with a metal material according to the present invention is as follows in detail. At first, a plate of FRP with a metal sheet attached thereto is formed by a conventional manner or NAT method (shown in an upper portion of FIG. 18). By chemical treatment method in which this plate of FRP with a metal sheet attached thereto is immersed in a group of large connected tanks sequentially, etc., the metal sheet is provided with preferable nature for adhesion. On the other hand, in preparation a metal material to be joined by adhesion with the sheet material through designing and mechanical working, a wall made of synthetic resin is formed so as to surround the place of a face of adhesion. Before forming the wall, surface treatment for joining by injection molding is conducted for the metal material obtained through mechanical working, etc. After this, this metal material itself is inserted into a mold for injection molding, and a certain resin for injection molding is injected onto the surface of the metal material to form a surrounding wall. This surrounding wall is one in periphery of the place to be a face of adhesion with a height of 0.3 to a several mm.

In the next, the formed object of metal material is fixed to some holder with its face to be joined by adhesion being in horizontal, and one component epoxy adhesive is filled somewhat overly on the face to be joined by adhesion within a wall surrounding the face as a pool form. In the next, the formed object of metal material is entered into a large vacuum bag or large autoclave and operation of decompression-returning to a normal pressure is conducted with gas, etc., solved in the adhesive degassed. Then, for the above plate of CFRP with a metal sheet having been subjected to surface treatment attached thereto, one component epoxy adhesive is painted on a portion to be a face of adhesion of the metal sheet in a thin manner, then also these are entered into a large desiccator or large autoclave and operation of decompression-returning to a normal pressure is conducted with gas, etc., solved in the adhesive degassed for preparation. This plate of CFRP with adhesive thereon is placed on the above formed object of metal fixed to a holder so as to be in a decided position, and then these are pressed a little to be fixed, after which these are placed in a hot air drier as it is at a temperature of 150° C. or more to cure adhesive.

### [3] Technique for Thickness of Layer of Adhesive to be 0.3 mm or More

While techniques of joining by injection molding was explained generally in the above explanation of NMT and New NMT, specific methods used in the present invention will be explained below. In a case of joining a plate material of CFRP with a plate material of Al alloy A70075 by adhesion and joining a plate material of CFRP with a plate material of 64 TI alloy, a frame wall shaped object for retaining adhesive as a kind of pool is formed for each of the cases through NMT or New NMT. There are structures shown in FIGS. 15, 16, 17 and 18, as shapes thereof. FIG. 17 shows one in which an island or ford-like projection is provided in a center position as a spacer so as not to be shallow in this position due to some strain in a case where this pool is shallow with a depth of 0.3 mm and wide. The center of a face of adhesion is a position where thickness of layer of cured adhesive may be zero mm as there is no movement of upper and lower faces (in direction of thickness) under thermal shock, the projection can act as a spacer. Further, optimum resin for this joining by injection molding will be above mentioned PPS resin “SGX120”. The reason therefor is such that, with this pool-like wall, extremely high strength of joining by injection molding is not necessary between the resin material joined by injection molding and the metal material and no trouble seems to occur in advance of process in time when adhesive is cured, for heat resistance of joining strength, with only low ability of keeping ability of form under a temperature of 200° C. Therefore, NMT treatment method for AL alloy and New NMT treatment method may be a simple surface treatment method developed at an early stage, and to say clearly NAT treatment method for Al alloy or for 64 Ti alloy is useful sufficiently.

On the other hand, a matter to be cared in the process is such that, when the plate of Al alloy or 64 Ti alloy having been subjected to NAT treatment is inserted into the metal mold for injection molding in the injection molding instrument and, after joining by injection molding, is advanced to a step of joining by adhesion using epoxy adhesive, such a problem occurs whether the surface of the metal material having been subjected to NAT treatment can exhibit effect as it is or not. There is possibility such that a portion in contact with a face of adhesion is sandwiched between the molds for injection molding so that originally complex ultrafine irregularities are broken, or possibility such that dissolved gas generated in time of joining by injection molding is adsorbed on or attached to the originally complex irregularities to cause performance of adhesion to be lowered. Therefore, it is considered that newest NAT treatment including a degreasing-cleaning step should be conducted the metal material itself with the object of PPS resin joined by injection molding attached thereto. In this respect, there is no problem in a case where NMT treatment is conducted for Al alloy, or NAT treatment is conducted after a pool shaped object made of PPS has been joined by injection molding.

However, it is preferred to avoid conducting NAT treatment after New NMT treatment has been conducted for 64 Ti alloy material and after this a pool shaped object made of PPS has been joined by injection molding. This is because NAT treatment Ti alloy includes a step of immersing it in a strong alkali aqueous solution to dissolve the PPS resin. In short, it required to devise not to scratch configuration of ultrafine irregularities in the area of a portion within the pool on the face of 64 Ti alloy having been subjected to treatment beforehand in the step of joining by injection molding of PPS resin “SGX120” (devising of shape of the metallic mold), and, as it is assumed that pyrolized gas of injected resin is attached to this area of a portion within the pool to be cured, it will be necessary to dissolve it with toluene, etc., and wipe it away.

In a same way, there are inventions regarding joining of a metal sheet by adhesion with a CFRP material or a FRP material (Patent Documents 2, 4, 6 and 7). With these, there is a step of conducting NAT treatment for the metal sheet, paint adhesive thinly thereon and placing it on a layered CFRP prepregs or GFRP prepregs at last. While after this these are integrated by an autoclave method to be a CFRP with a metal sheet attached thereto or a FRP with a metal sheet attached thereto, the metal sheet joined by adhesion gets dirty in this step of joining by adhesion and curing. That is, there is a possibility such that uncured adhesive or matrix resin moves to be attached the face and to form cured film. Not only in such a case of dirt attached thereto clearly but including a case apparently see to be clear, NAT treatment is conducted twice for this metal material. As second NAT treatment is conducted in a situation with the metal sheet attached on the FRP material, NAT treatment may give somewhat disturbance when strong acid or strong base is used therefor. While as metal sheets used in experiments, there are not only various Al alloys, but also SUS304, SUS316, copper C1100, etc., for which sheets could be obtained, it is only Al alloy that treatments of NMT, New NMT and NAT can be conducted with a aqueous solution of weak acid and weak base. In this respect, an Al alloy sheet is preferable for a sheet material.

[4] Regarding two component epoxy adhesive

While one component epoxy adhesive is considered mainly for the present invention, it is not impossible to use two component epoxy adhesive. Each kind of metal piece having been subjected to NAT treatment has a surface of metal suitable for joining by adhesion. In a case where metals of a same kind are joined by adhesion of NAT type, shear strength using a one component epoxy adhesive commercially available is 60 to 80 MPa at an ordinary temperature. With a one component epoxy adhesive “EW2040” (sold by Three M Japan Co. Ltd., main company in Tokyo, Japan) excellent in heat resistance used in the present invention and in the prior invention, shear strength was about 60 MPa. Similarly, with “DP420” (sold by Three M Japan Co. Ltd., main company in Tokyo, Japan) used most widely as two component epoxy adhesive, shear strength is about 40 MPa at an ordinary temperature. With adhesive taken as reliable as one for structure, shear strength of adhesion of a pair joined by adhesion obtained using a two component epoxy adhesive was generally about ⅔ of one obtained using a one component epoxy adhesive. The present inventor did not conduct detailed comparation tests regarding how about heat resistance of pairs formed by adhesion through preparing formed objects (test pieces) shown in FIG. 1, measuring shear strength at temperatures of 100° C., 150° C., etc. It can be assumed that such a high heat resistance cannot be obtained as with the above “EW2040” providing 30 MPa at a temperature of 150° C. In short, it is unavoidable as development having an object of acquiring high joining strength at a high temperature is not conducted for two component epoxy adhesive.

Here, condition of curing of one component epoxy adhesive is heating at high temperature with a temperature of 150 to 170° C. and heating time of 20 to 60 minutes. In short, adhesive is cured and solidified at a temperature of 150 to 170° C. Therefore, when the obtained pair joined by adhesion returns to a normal temperature, the adhesive layer contracts as the metal material contracts by an amount of coefficient of linear expansion×150° C., being forced to contract in a manner different from its natural contraction. In short, the layer of cured adhesive is forced to contract by an amount different from its proper efficient of linear expansion, irrespective of cooling to a temperature of 23° C. or further cooling to −50° C. It can be said that this strong forcing (inner stress) is kept by both of softness of the cured object of adhesive and high strength of adhesion of the metal material having been subjected to NAT treatment with the cured object of adhesive. Actually, for a pair joined by adhesion using one epoxy adhesive has a thickness so small as 0 (in a level of measurement) to 0.1 mm as for a formed object (test piece) shown in FIG. 1, the layer of adhesive follows the thermal expansion-contraction, so that coefficient or the like substantially no relation. Then, a case of a structure by adhesion shown in FIG. 8, for example, is assumed that in which one is a plate of CFRP and the other is a plate of Al alloy A7075 with a layer of cured adhesive has a thickness of 1 mm.

With this structure of adhesion, the lower face portion (as shown in the figure) of the layer of cured adhesive expands and contracts according to coefficients of linear expansion of 0.2×10⁻⁵K⁻¹ and 5×10⁻⁵K⁻¹ for crossed lateral direction and vertical direction, so to say, according to coefficient of expansion 2.6×10⁻⁵K⁻¹ as an averaged value for the layer of cured adhesive and the plate of metal. The upper face portion of the layer expands and contracts according to coefficient of linear expansion of 2.3×10⁻⁵K⁻¹ as an averaged value for the layer of cured adhesive and the plate of CFRP similarly, so that the layer of cured adhesive become an object having a deformed trapezoidal shape. Whether the present invention is of a success or not depends on whether the object having a trapezoidal shape of cured adhesive taken as a soft material consists without breaking when it is cooled to a temperature of −50° C. to be deformed in largest extent.

How about when two component epoxy adhesive is used? Considering that the adhesive has originally a low heat resistance, limit of range of temperature for thermal shock test will be −50° C./+50° C. For an aircraft or flying entity, it seems that two component epoxy adhesive can be used sufficiently as it can be used within the above range of temperature unless it is placed near a portion of engine portion or a light emitting portion generating heat. As there is an adhesive that can be cured completely at a condition of curing for adhesive of −50° C.×48 hours, operation of adhesion within a room placed in a factory is possible in such a case. With a curing temperature of adhesive being 45° C., lowering of temperature to −50° C. corresponds to lowering by 90K from the intermediate temperature (curing temperature), so the lowering is merely a half of lowering of 220 K as from 170° C. to −50° C. when one component epoxy adhesive is used. In such meaning, it can be said that low strength of adhesion is somewhat depressed.

In any way it is a matter decided by a size of area of adhesion. For example, in a case of a small flying object such as a small drone, operation using one epoxy adhesive is possible, as preparation of CFRP portion using an autoclave and final adhesion step can be conducted by heating at high temperature. On the other hand, if there is some hindrance such that a large part cannot be placed in an autoclave for a step of adhesion, etc., operation can be conducted using two component epoxy adhesive. Above all, insufficient performance of two component epoxy adhesive is heat resistance. There has been no use of two component requiring for its heat resistance in past. However, there are some matters enabling steps to be more easy in the present invention. When application of the present invention is advanced, study of raising heat resistance of two component epoxy adhesive will advance.

An integrated article of FRP with a metal material through adhesion and a method for producing the same according to the present invention presents technology of integrating a CFRP material with a metal material of a high strength including Al alloy of duralumin, etc., or a CFRP or FRP material with a Ti alloy material, to have a high strength by adhesion, and provides such an integrated object enduring a test of thermal shock or a test of heat resistance and moisture resistance.

### BRIEF EXPLANATION OF DRAWINGS

FIG. 1 shows a pair (test piece) formed by joining metal pieces by adhesion for measuring shear strength between the metals.

FIG. 2 shows a pair formed by joining a CFRP material with a metal piece by adhesion for measuring tensile strength thereof.

FIG. 3 is a view of a structure showing a CFRP material composed of long carbon fibers aligned in a direction and a cured object of thermosetting plastics.

FIG. 4 is a view of a structure example in which CFRP prepregs having long carbon fibers aligned in a direction are layered so as to cross each other at an angle of 90 degrees.

FIG. 5 is a view of structure showing a CFRP material structure as an example of structure in which cloth type CFRP prepregs are layered.

FIG. 6 is a view of structure showing a CFRP material structure, in which the left side portion is one formed by layering uni-directional CFRP prepregs with fiber direction rotated by 90 degrees sequentially, and the right side portion is one formed by layering uni-directional CFRP prepregs aligned for fiber direction.

FIG. 7 is a view of structure showing a CFRP material structure, in which the left side portion is one formed by layering CFRP prepregs having long carbon fibers aligned in a uni-direction manner, and the right side portion is one formed by layering uni-directional CFRP prepregs and uni-directional GFRP prepregs so as to cross each other for joining with a plate material of Ti alloy.

FIG. 8 shows an example of a simplest form a pair formed by adhesion with a layer of cured adhesive sandwiched.

FIGS. 9(a) to 9(c) show a schematical model of a portion of cured object of adhesive (50 mm×50 mm×1.0 mm) extracted from a pair formed by adhesion of a metal plate with a CFRP plate, in which FIGS. 9(a) to 9(c) show its form at curing temperature of +150° C. and at a temperature of cooled state −50° C.

FIGS. 10(a) and 10(b) show a schematical model of a portion of cured object of adhesive (25 mm×25 mm×1.0 mm) extracted from a pair formed by adhesion of a metal plate with a CFRP plate, in which FIGS. 10(a), 10(b) show its form at curing temperature of +150° C. and at a temperature of cooled state −50° C.

FIGS. 11(a) and 11(b) show a schematical model of a portion of cured object of adhesive (25 mm×25 m×0.5 mm) extracted from a pair formed by adhesion of a metal plate with a CFRP plate, in which FIGS. 11(a), 11(b) show its form at curing temperature of +150° C. and at a temperature of cooled state −50° C.

FIGS. 12(a) to 12(c) show a schematical model of a portion of cured object of adhesive (50 mm×50 m×1.0 mm extracted from a pair formed by adhesion of a metal plate with a CFRP plate, in which FIGS. 12(a), 12(b) show its form at curing temperature of +150° C. and at a temperature of cooled state −50° C.

FIGS. 13(a) to 13(c) show a schematical model of a portion of cured object of adhesive (50 mm×50×0.5 mm) extracted from a pair formed by adhesion of a metal plate with a CFRP plate, in which FIGS. 13(a) to 13(c) show its form at curing temperature of +150° C. and at a temperature of cooled state −50° C.

FIGS. 14(a) to 14(c) show a schematical model of a portion of cured object of adhesive (100 mm×100×0.5 mm) extracted from a pair formed by adhesion of a metal plate with a CFRP plate, in which FIGS. 14(a) to 14(c) show its form at curing temperature of +150° C. and at a temperature of cooled state −50° C.

FIG. 15 shows a view of structure in case of joining a CFRP plate with a metal plate by adhesion similarly as in FIG. 8 with a pool shaped square frame to be filled with adhesive securing thickness thereof.

FIG. 16 shows a view of structure in case of joining a CFRP plate with a metal plate by adhesion similarly as in FIG. 8 with a pool shaped, deformed square frame to be filled with adhesive securing thickness thereof.

FIG. 17 shows an example of the square frame shown in bin FIG. 15 with an island for securing thickness disposed in the center thereof.

FIG. 18 shows a view of structure in case of joining a metal plate with a plate of CFRP or CFRTP with a metal sheet joined by adhesion thereto, in which a pool shaped square frame to be filled with adhesive is formed so as to secure thickness thereof.

FIG. 19 shows an example in which a metal plate is joined by adhesion via a metal sheet to the right side portion of a plate of CFRP having a laminated structure shown in FIG. 7.

### DETAILED EXPLANATION OF EMBODIMENTS

The present invention will be explained for best modes of embodiments bellow.

### Experimental Examples 1

Experimental examples of the present will be explained below.

(a) Observation with an Electron Microscope

An electron microscope was used mainly for observing a surface of a base material. Observation was conducted using a scanning electron microscopes (SEM) “SSM-7000F” (manufactured by Nihon Denshi Co. Ltd., main company in Tokyo, Japan) with 1 to 2 kV.

### (b) Measurement of Joining Strength

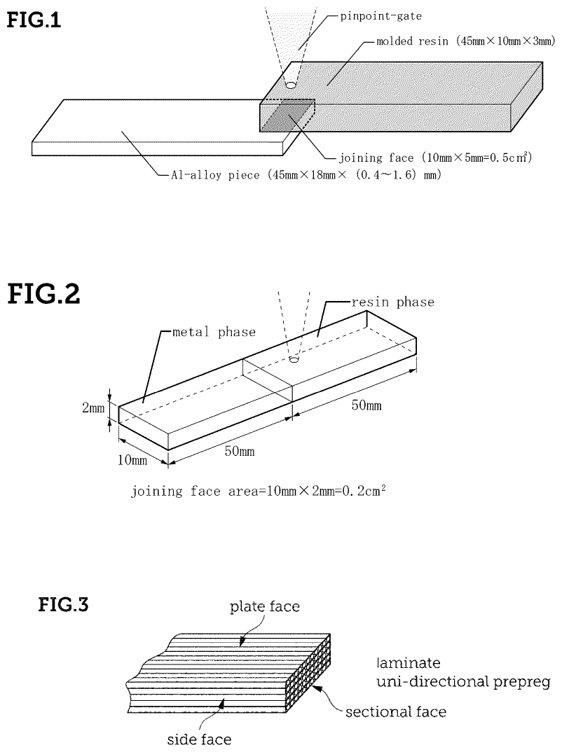

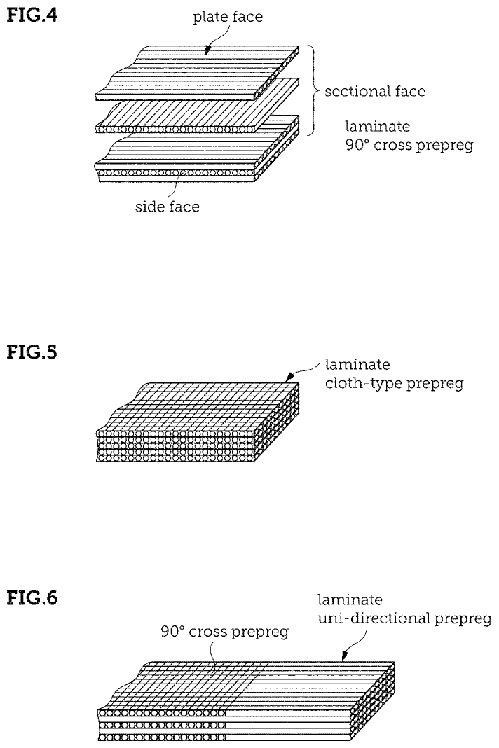

Breaking force in tensile breaking of a joined article by adhesive (test piece shown in FIG. 1) measured with a tensile test instrument was taken as shear strength of adhesion. Further, breaking force in tensile breaking of a joined article by adhesive (test piece shown in FIG. 2) measured with a tensile test instrument was taken as tensile strength of adhesion. Used tensile test instrument was “AG-500N/1 kN” (manufactured by Shimadzu-seisakusho Co. Ltd.: main company in Kyoto, Japan), and measurement was conducted at a tension speed of 10 mm/min.

### (c) Measurement of Shear Stickiness of Adhesion

Measurement of “shear stickiness of adhesion” referred to in the present invention is a test in which, with strength of tensile strength of adhesion regarding a joined article by adhesion (test piece shown in FIG. 1) measured preliminarily, force of about 75% of the above is applied to test piece repeatedly and successively, without tensile breaking of the test piece with a tensile test instrument. Operation of a tensile test instrument is conducted setting mode in operation software so as to perform the above operation, setting highest tensile force to the above one, lowest tensile force to about ⅔ thereof and tension speed to ±10 mm/min. If the test piece is not broken with this, a test is conducted adding about 2 MPa to the above highest tensile force and applying same repeated load for 300 times. In a case where the test piece is not broken even with this, same operation is repeated adding further about 200 MPa. Thus, such operation is conducted successively until the test piece shown in FIG. 1 is broken. When the test piece is broken, acquired highest tensile force before breaking is indicated by MPa, which is taken as “shear stickiness of adhesion” in this measurement method. Used tensile test instrument is “AG-500N/1 kN” mentioned above.

### (d) Nondestructive Test

Detachment of a test piece can be confirmed sufficiently, as a simple manner, by a method of painting aqueous penetrating liquid on outer portion of a layer of adhesion, wiping it off and seeing whether colored portion is wiped out or not. However, in a case where it is desired to confirm to what extent detachment is spread, it was confirmed using a nondestructive test instrument. Used instrument is a supersonic type of nondestructive test instrument “MS Line” (manufactured by Hitachi Power Solutions Co. Ltd. (main company in Ibaraki, Japan).

### [Thermal Shock Cycle Test]

A small type cooling-heating thermal shock test instrument “TSE-12-A” manufactured by Espec Co. Ltd. (main company in Osaka, Japan) was used for thermal shock cycle test in this experiment. Condition of the thermal shock cycle test conducted in a standard manner was such that temperature of cooling room is −50° C., temperature of high temperature room is 150° C., staying time in each room is 25 minutes and time for transfer is 5 minutes. The test instrument itself is placed in a room where temperature is constantly adjusted to 27° C. and automatic operation was conducted by raising the temperature of the cooling room periodically to the room temperature to melt frozen portion in the instrument in a natural manner. However, such as an accident that portion in the instrument is frozen may occur in a high humidity time, in order to prevent such accident completely, test was conducted by keeping a safe operation by ceasing operation of the test instrument in weekend days, new year days, successive holidays in May, August, etc.

### EXPERIMENT EXAMPLE

### Surface Treatment of Each Material

### Experiment Example 1

### Surface Treatment of Ai Alloy A7075 (NAT Treatment (Preliminary Treatment for Adhesion))

Plates of Al alloy A7075 of kinds of shapes with thickness 1 to 3 mm were purchased and subjected to mechanical working to obtain Al alloy pieces having necessary form. An aqueous solution containing degreaser for aluminum “NA-6” (made by Meltex Co. Ltd.: main company in Tokyo, Japan) by 10% was filled to be at 60° C. in a tank for immersion, in which the above aluminum alloy pieces were immersed for 5 minutes, and after then the pieces were rinsed with tap water (Ota city, Gumma prefecture, Japan) (abbreviated below). Next, an aqueous solution of hydrochloric acid having a concentration of 1% was made ready to be at 40° C. in another tank, in which the pieces were immersed for 1 minute, and after then the pieces were rinsed with water. Next, an aqueous solution of caustic soda having a concentration of 1.5% was made ready to be at 40° C. in still another tank, in which the pieces were immersed for 4 minutes, and after then the pieces were rinsed with water. Next, an aqueous solution of nitric acid having a concentration of 3% was made ready to be at 40° C. in still another tank, in which the pieces were immersed for 3 minutes, and after then the pieces were rinsed with water. Next, an aqueous solution of hydrazine hydrate having a concentration of 3.5% was made ready to be at 60° C. in still another tank, in which the pieces were immersed for 2 minutes, and then the pieces were immersed in an aqueous solution of hydrazine hydrate having a concentration of 0.5% at 33° C. made ready in still another tank for 0.5 minute, and after then the pieces were rinsed with water. Further, after the pieces were immersed in hydrogen peroxide water having a concentration of 5% for 5 minutes, the pieces were rinsed well with water. The aluminum alloy pieces having been subjected to the above treatment were placed in a warm air drier set to be at a temperature of 67° C. for 15 minutes and dried there. After this, the pieces were wrapped together with clean aluminum foil to be stored.

### Experiment Example 2

### Surface Treatment of Al Alloy A7075 (Treatment of NMT 2 (Preliminary Treatment for Joining by Injection Molding))

Plates of Al alloy A7075 of kinds of shapes with thickness 1 to 3 mm were purchased and subjected to mechanical working to obtain Al alloy pieces having necessary form. An aqueous solution containing the above degreaser for aluminum “NA-6” by 10% was filled to be at 60° C. in a tank for immersion, in which the above aluminum alloy pieces were immersed for 5 minutes, and after then the pieces were rinsed with water. Next, an aqueous solution of hydrochloric acid having a concentration of 1% was made ready to be at 40° C. in another tank, in which the pieces were immersed for 1 minute, and after then the pieces were rinsed with water. Next, an aqueous solution of caustic soda having a concentration of 1.5% was made ready to be at 40° C. in still another tank, in which the pieces were immersed for 4 minutes, and after then the pieces were rinsed with water. Next, an aqueous solution of nitric acid having a concentration of 3% was made ready to be at 40° C. in still another tank, in which the pieces were immersed for 3 minutes, and after then the pieces were rinsed with water. Next, an aqueous solution of hydrazine hydrate having a concentration of 3.5% was made ready to be at 60° C. in still another tank, in which the pieces were immersed for 1 minute, and then the pieces were immersed in an aqueous solution of hydrazine hydrate having a concentration of 0.5% at 33° C. made ready in still another tank for 0.5 minute, and after then the pieces were rinsed with water. The aluminum alloy pieces having been subjected to the above treatment were placed in a warm air drier set to be at a temperature of 67° C. for 15 minutes and dried there. After this, the pieces were wrapped together with clean aluminum foil to be stored.

### Experiment Example 3

### Surface Treatment of Ai Alloy A6061 (NAT Treatment (Preliminary Treatment for Adhesion))

Plates of Al alloy A6061 of kinds of shapes with thickness 0.5 to 2 mm were purchased and subjected to mechanical working to obtain Al alloy pieces having necessary form. An aqueous solution containing the above degreaser for aluminum “NA-6” by 10% was filled to be at 60° C. in a tank for immersion, in which the above aluminum alloy pieces were immersed for 5 minutes, and after then the pieces were rinsed with water. Next, an aqueous solution of hydrochloric acid having a concentration of 1% was made ready to be at 40° C. in another tank, in which the pieces were immersed for 1 minute, and after then the pieces were rinsed with water. Next, an aqueous solution of caustic soda having a concentration of 1.5% was made ready to be at 40° C. in still another tank, in which the pieces were immersed for 4 minutes, and after then the pieces were rinsed with water. Next, an aqueous solution of nitric acid having a concentration of 3% was made ready to be at 40° C. in still another tank, in which the pieces were immersed for 3 minutes, and after then the pieces were rinsed with water. Next, an aqueous solution of hydrazine hydrate having a concentration of 3.5% was made ready to be at 60° C. in still another tank, in which the pieces were immersed for 2 minutes, and then the pieces were immersed in an aqueous solution of hydrazine hydrate having a concentration of 0.5% at 33° C. made ready in still another tank for 0.5 minute, and after then the pieces were rinsed with water. Further, after the pieces were immersed in hydrogen peroxide water having a concentration of 5% for 5 minutes, the pieces were rinsed well with water. The aluminum alloy pieces having been subjected to the above treatment were placed in a warm air drier set to be at a temperature of 67° C. for 15 minutes and dried there. After this, the pieces were wrapped together with clean aluminum foil to be stored.

### Experiment Example 4

### Surface Treatment of 64 Ti Alloy (NAT Treatment (Preliminary Treatment for Adhesion))

Plates of 64 Ti alloy having various shapes (Ti alloy pieces) with thickness 1 to 3 mm were prepared. An aqueous solution containing the above degreaser for aluminum “NA-6” by 10% was filled to be at 60° C. in a tank for immersion, in which the above Ti alloy pieces were immersed for 5 minutes, and after then the pieces were rinsed with water. Next, an aqueous solution of ammonium hydrogen bifluoride having a concentration of 5% was made ready to be at 6 5° C. in another tank, in which the 64 Ti alloy pieces were immersed for 5 minutes, and after then the pieces were rinsed with water. Next, an aqueous solution of nitric acid having a concentration of 3% was made ready to be at 40° C. in still another tank, in which the 64 Ti alloy pieces were immersed for 3 minutes, and after then the pieces were rinsed with water. Next, an aqueous solution containing potassium permanganate by 2% and caustic potash by 3% was made ready to be 70° C. in another tank, in which the Ti alloy pieces were immersed for 30 minutes, and after then the pieces were rinsed with water. Next, an aqueous solution containing sodium chlorite by 5% and caustic soda by 10% was made ready to be 55° C. in another tank, in which the 64 Ti alloy pieces were immersed for 10 minutes, and after then the pieces were rinsed with water. Next, hydrogen peroxide water having a concentration of 1.5% was made ready, in which the 64 Ti alloy pieces were immersed for 1 minute, and after then the pieces were rinsed with water. The aluminum alloy pieces having been subjected to the above treatment were immersed in a tank provided with an ultrasonic oscillation end for several minutes, and after then the pieces were rinsed with water. Next, an aqueous solution of triethanolamine having a concentration of 0.2% was made ready to be 40° C. in another tank, in which the 64 Ti alloy pieces were immersed for 15 minutes, and after then the pieces were rinsed well with water. Then, the 64 Ti alloy pieces were placed in a warm air drier set to be at a temperature of 80° C. for 15 minutes and dried there, after which the pieces were wrapped together with clean aluminum foil to be stored.

### Experiment Example 5

### Surface Treatment of 64 Ti Alloy (New NMT Treatment (Preliminary Treatment for Joining by Injection Molding))

Plates of 64 Ti alloy having various shapes (Ti alloy pieces) with thickness 1 to 3 mm were prepared. An aqueous solution containing the above degreaser for aluminum “NA-6” by 10% was filled to be at 60° C. in a tank for immersion, in which the above Ti alloy pieces were immersed for 5 minutes, and after then the pieces were rinsed with water. Next, an aqueous solution of ammonium hydrogen bifluoride having a concentration of 5% was made ready to be at 6 5° C. in another tank, in which the 64 Ti alloy pieces were immersed for 4 minutes, and after then the pieces were rinsed with water. Next, an aqueous solution of nitric acid having a concentration of 3% was made ready to be at 40° C. in still another tank, in which the 64 Ti alloy pieces were immersed for 3 minutes, and after then the pieces were rinsed with water. Next, an aqueous solution containing potassium permanganate by 2% and caustic potash by 3% was made ready to be 70° C. in another tank, in which the Ti alloy pieces were immersed for 30 minutes, and after then the pieces were rinsed with water. Next, an aqueous solution containing sodium chlorite by 5% and caustic soda by 10% was made ready to be 55° C. in another tank, in which the 64 Ti alloy pieces were immersed for 10 minutes, and after then the pieces were rinsed with water. The 64 Ti alloy pieces having been subjected to the above treatment were placed in a warm air drier set to be at a temperature of 80° C. for 15 minutes and dried there, after which the pieces were wrapped together with clean aluminum foil to be stored.

### Experiment Example 6

Preparation of Pairs of CFRP Plate with AL Alloy A7075 Plate Joined by Adhesion

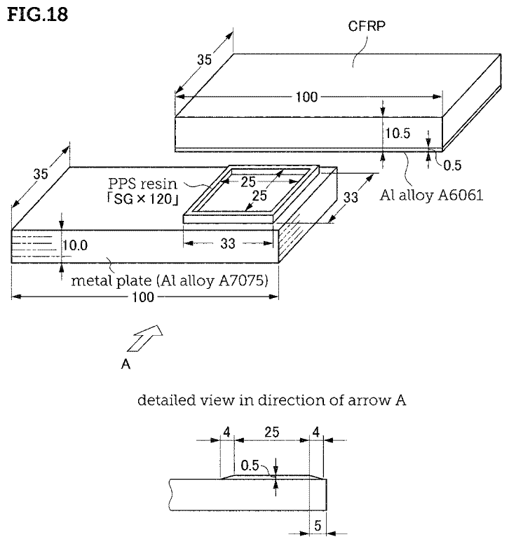

Obtaining uni-directional prepreg of CFRP “P2255S-25” having a thickness of 0.2 mm (made by Toray Co. Ltd.: main company in Tokyo, Japan)”, plates of CFRP with direction of CF aligned having a dimension of 110 mm×40 mm with a thickness of 10 mm were prepared. Then sheet pieces of Al alloy A6061 having a dimension of 10 mm×40 mm with a thickness of 0.5 mm having been subjected to the surface treatment explained in Experiment Example 3 were made ready, the above one component epoxy adhesive “EW2040” was painted on one face of these sheet pieces of alloy, the painted sheet pieces were laminated on the CFRP plates respectively, which were integrated as laminated objects by an autoclave method. Cutting each of the laminated objects to ones of a dimension 100 mm×35, a large number of CFRP plates having a thickness of 10.5 mm with a sheet of Al alloy attached thereto were obtained (upper side member in FIG. 18).

Next, plates of Al alloy A7075 having a thickness of 2 mm, as a material shown in FIG. 18, were obtained and from these a large number of small pieces having a dimension of 100 mm×35 mm. Conducting chemical treatment for these by a method in Experiment Example 1 to be objects by NAT treatment. Then five of them were laminated to form a plate having a thickness of 10 mm for each. For this, each face of them was joined by all face to all face adhesion with the above epoxy adhesive “RW2040”, thus obtaining rectangular plate having dimension of 100 mm×35 mm×10 mm. As it is considered that a layered object obtained lamination has an increased thickness by adhesive, the form of 100 mm×35 mm×10 mm was prepared by mechanical working. In order to form a concave portion surrounded by a wall (referred to as a pool frame), a metal mold for joining by injection molding. That is, the wall shaped object formed in a square shape shown on the left side in FIG. 18 was formed with injected resin such as a kind of a weir for preventing liquid-like adhesive from flowing out.

This pool frame was formed by injection molding. That is, surface of [a plate of Al alloy A7075 having a dimension of 100 mm×35 mm×10 mm obtained by lamination was subjected to treatment of NAT 2 and then the plate of Al alloy was inserted into a metal mold for joining by injection molding, into which the above PPS resin “SGX120” as one for joining by injection molding to form the pool frame. Thus, the pool-like square frame as a wall-shaped object depicted in a left side position of FIG. 15 was formed. Subtle adjustment of height of the resin wall of the square frame can be conducted at a time when the metallic mold for joining by injection molding is prepared, or may be conducted by shaving the molded frame to be of a desired height after it was formed by injection molding. In this experiment, after forming an object of initial design having a height of 1.5 mm, it was shaved as mechanical working to be of a height of 0.5 mm. In the next, it subjected to NAT treatment (preliminary treatment for adhesion) explained in Experiment 1 and then dried.

An object obtained through working having been subjected to NAT treatment was kept to be in a horizontal state and a solution (exactly, a suspension) consisting of one component epoxy adhesive “EW2040” by 2% and MIBK solvent by 98% was painted with a writing brush on a portion of the pool-shaped square frame corresponding to a bottom (penetration into irregularities of the surface), and solvent was dried in a warm air drier at 50° C. for 20 minutes to be volatilized.

The plate of Al alloy A7075 having the pool-shaped square frame thereon filled with adhesive was placed on a horizontal stand, and the plate of CFRP with an aluminum sheet attached thereto on which adhesive is painted thinly was placed (laminated) in a reversed state, so that the two materials shown in FIG. 18 were laminated to form a pair joined by adhesion (FIG. 8). Then, an upper plate as a weight was placed further thereon. In order to prevent the pool-shaped square frame from being broken under the weight of the CFRP material and the upper plate, a space material of a substantially same thickness as the CFRP material was intervened therewith, and these members were fixed by a jig so as not to move each other. These members were placed in a large desiccator kept at a temperature of 50° C., pressure therein was lowered to 0.05 atmosphere with a vacuum pump, then air was supplied into the large desiccator and pressure was lowered again, and then was returned to a normal pressure (atmosphere) again, such operation being conducted for three cycles. This cyclic operation is for removing air having entered into the face of adhesion. In the next, these members were taken out and placed in a hot air drier set to a temperature of 170° C., where curing treatment of adhesive with 170° C. was ×25 minutes was conducted. After this the door of the hot air drier was opened to conduct cooling. In the next day, the assembled members were taken apart and the pair firmed by adhesion was taken out. While adhesive having overflowed was cured to be solidified in a periphery of the square frame, part that can be shaped off by mechanical working was removed and part having been cured to be solidified between the two materials were kept as it is. In this Experiment, the object of cured adhesive has a form of a rectangular sheet shown in FIGS. 11(a) and 11(b).

### Experiment Example 7

Preparation of Pairs of CFRP Plate with 64 Ti Alloy Plate Joined by Adhesion

CFRP prepreg of plain weave “C06363” (made be Toray Co. Ltd.: main company in Tokyo, Japan) was obtained and plates of CFRP each having a dimension of 110 mm×40 mm with a thickness of 10 mm were prepared. On the other hand, sheets of Al alloy A6061 having a dimension of 110 mm×40 mm with a thickness of 0.5 mm having been subjected to surface treatment by chemical treatment method (NAT treatment) explained in Experiment Example 3 were prepared, and one component epoxy adhesive “EW2040” was painted thereon. A sheet of them was laminated on one of the above plates of CFRP to be integrated to a laminated object as it is by an autoclave method. By cutting the obtained object, a CFRP plate having a thickness of 10.5 mm with a sheet of Al alloy A6061 attached thereto was obtained respectively.

On the other hand, 64 Ti alloy pieces having a dimension of 100 mm×35 mm×10 mm were obtained through mechanical working. A metallic mold for joining by injection molding prepared for forming a pool-shaped concave on this 64 Ti alloy plate was formed in a similar manner for the case of Al alloy plate shown in FIG. 18. Each of these plates of 64 Ti alloy was subjected to New NMT treatment by a method explained in Experiment Example 5, inserted into the above-mentioned metallic mold for injection molding and “SGX120” as a PPS resin for joining by injection molding was injected therein. Thus, an object was prepared with a pool-shaped square frame shown in FIG. 18 formed thereon. Here, desired shape and dimension of this square frame was obtained through the metallic mold for joining by injection molding and mechanical working. In this example, an initial height of 2 mm was made a height of 0.5 mm through mechanical working after injection molding. In the next, after being subjected to NAT treatment explained in Experiment Example 4, it was dried.

Obtained object having been subjected to NAT treatment was kept in a horizontal state, a solution (exactly, a suspension) consisting of one component epoxy adhesive “EW2040” by 2% and MIBK solvent by 98% was painted with a writing brush on a portion of the pool-shaped square frame corresponding to a bottom (penetration into irregularities of the surface), and solvent was dried in a warm air drier at 50° C. for 20 minutes to be volatilized. In the next, “EW2040” itself was poured into the pool-shaped square frame to a full state. On the other hand of this operation, a CFRP plate having a thickness of 10.5 mm with a sheet of Al alloy A6061 attached thereto as obtained beforehand was taken out, the above adhesive solution diluted with solvent is painted on a necessary place on the surface of the Al alloy, and this also was dried in a warm air drier at 50° C. for 20 minutes causing solvent to be volatilized. The plate of 64Ti alloy having the pool-shaped square frame thereon filled with adhesive was placed on a horizontal stand, and the plate of CFRP with an aluminum sheet attached thereto on which adhesive is painted thinly was placed in a reversed state, so that the two materials shown in FIG. 18 were laminated to form a pair joined by adhesion.

Then, a fixing jig and an upper plate as a weight were placed on them further. The laminated object as a pair to be joined by adhesion was fixed with a jig as a whole and a spacer intervened so that the square frame may not be broken with weight of the CFRP material and the upper plate and gap is not created. These members were placed in a large desiccator kept at a temperature of 50° C., pressure therein was lowered to 0.05 atmosphere with a vacuum pump, then air was supplied into the large desiccator and pressure was lowered again, and then was returned to a normal pressure again, such operation being conducted for three cycles. In the next, these members were taken out and placed in a hot air drier set to a temperature of 170° C., where curing treatment of adhesive with 170° C. was ×25 minutes was conducted. After this the door of the hot air drier was opened to conduct cooling. In the next day, the assembled members were taken apart and the pair firmed by adhesion was taken out. While adhesive having overflowed was cured to be solidified in a periphery of the square frame, part that can be shaped off by a luta was removed and part having been cured to be solidified between the two materials were kept as it is. In this, as joining of CFRTP with Al alloy A6061 is a known art presented by the present inventor, thus it is not explained in detailed here (see Patent Document 15).

### Experiment Example 8

−50° C./+150° C. thermal shock test 3000 Cycle test

### Experiment Example 8

Two pairs joined by adhesion for each of the obtained in Experiment Examples 77 and 8, that is, 4 pairs joined by adhesion in total were subjected to 3000 cycle test for −50° C./+150° C. thermal shock. The test pieces were taken out also at a midway time when 1000 cycles finished and 2000 cycles finished. Thus, while test was conducted by inspecting with a nondestructive test instrument whether there is an abnormal portion or not, such abnormal test piece was not found, including those for which 3000 cycles finished.

With Experiment Example 6, the uni-directional CFRP material was joined by adhesion with an Al alloy A7075 via an object of cured adhesive having a thickness of 0.5 mm. While it was assumed the object of cured adhesive has a sufficient resistance ability to thermal shock as it has a same form as one shown in FIGS. 11(a) and 11(b), there was actually no appearance of breaking in the layer of cured adhesive. This is as considered, due to such thickness of the layer of cured adhesive, so that usefulness of the present invention could be confirmed.

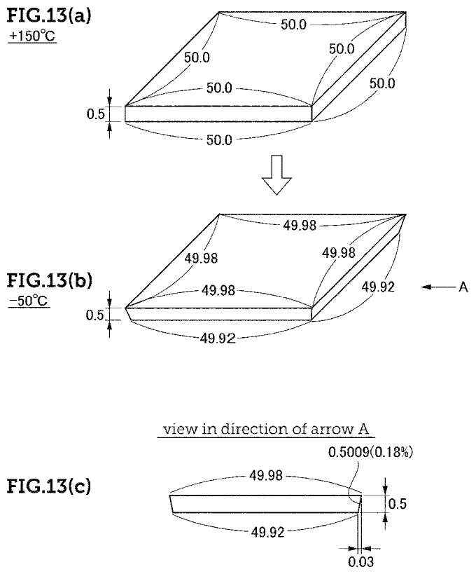

Further, with Experiment Example 7, the CFRP material with cloth-type CFRP prepregs laminated was joined by adhesion with an 64 Ti alloy through forming an layer of cured adhesive having a dimension of 25 mm×25 mm with a thickness of 0.5 mm. This layer of cured adhesive is assumed to have resistance ability to thermal shock higher than the layer of cured adhesive having a dimension of 50 mm×10 mm 50 mm×0.5 mm wider than this shown in FIGS. 13(a) to 13(c). While there was actually no appearance of breaking in the layer of cured adhesive in the above experiments, this is as considered, due to the layer of cured adhesive having such thickness, so that usefulness of the present invention could be confirmed.

### Thought Experiment 1

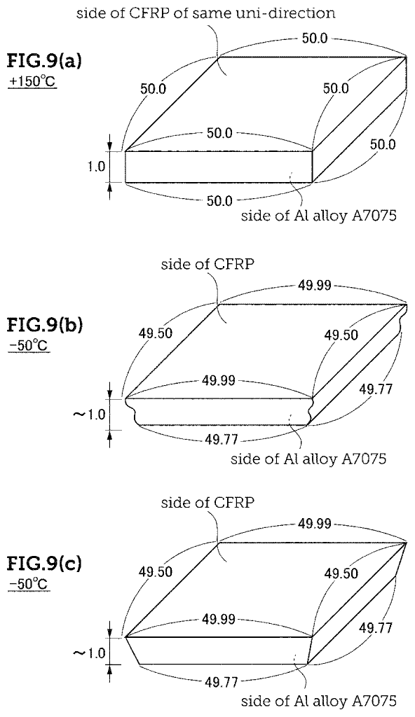

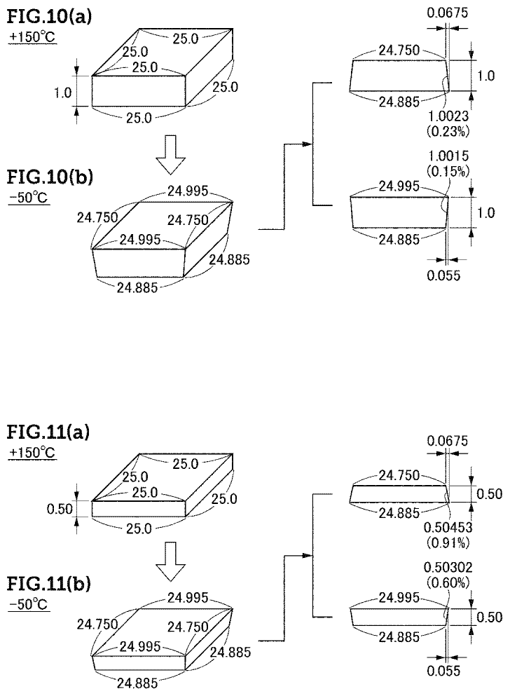

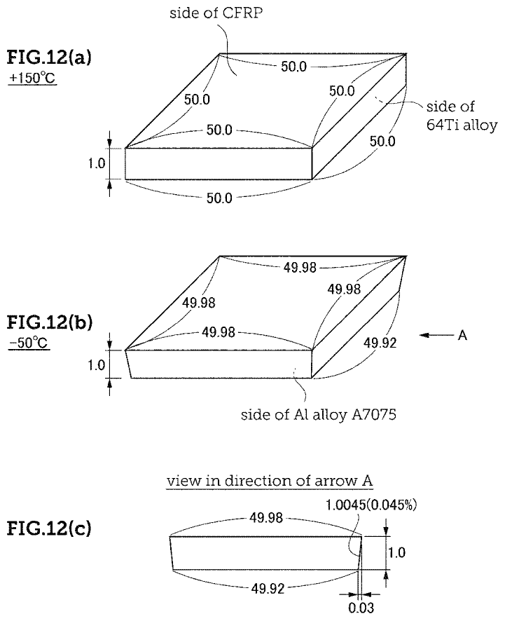

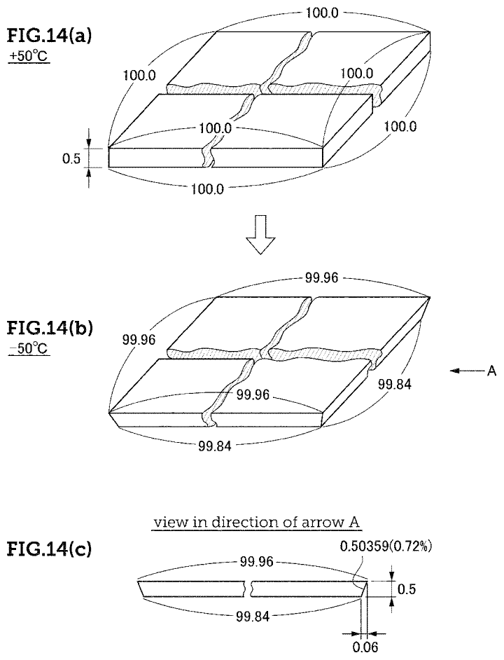

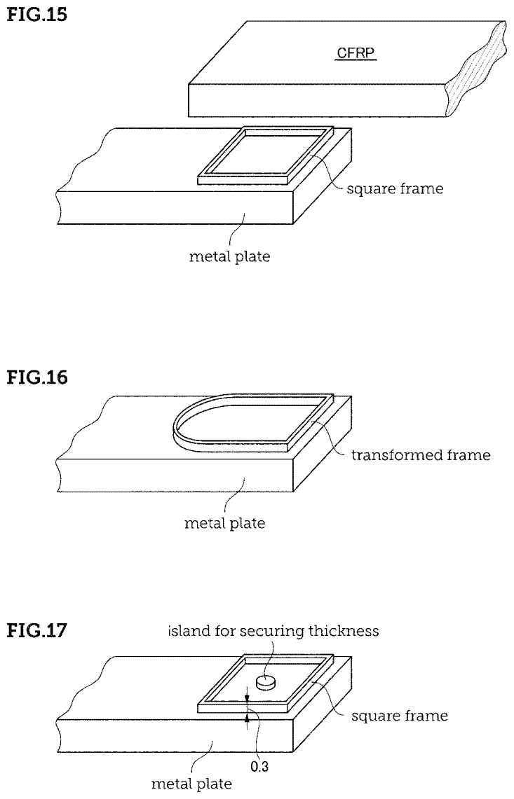

From the above results of experiment, thought is possible as follows. For a plate of CFRP formed by adhesion of laminated uni-directional prepregs with direction of fibers aligned, its coefficient of linear expansion in the direction of fibers becomes 0.1×10⁻⁵K⁻¹ to substantially that of CD itself. In all direction perpendicular to this direction, coefficient of linear expansion becomes (5 to 8)×10⁻⁵K⁻¹ on which coefficient of linear expansion of cured epoxy adhesive has a main influence, giving a large difference between these. Assuming that this coefficient of linear expansion appears on a face of the CFRP plate or has an influence, the present inventor has argued about change of form of a layer of cured adhesive occupying a space of between the CFRP material and the metal material through assuming and experiment. In short, it has been argued that form of a cured object of one component epoxy adhesive (layer of cured adhesive) having a high heat resistance is deformed by external force loaded on the face of adhesion as shown in FIGS. 9(a) to 14(c) by modelling. In this, consideration was made about whether the layer of cured adhesive is broken or not, and about whether concentration of stress exceeding strength of adhesion occurs or not specifically in angular portions at four corners thereof. Further, consideration was made about what characteristics a layer of cured adhesive as an object of cured adhesive being a solid body, and metal of lead, pure aluminum, soft iron, etc., exhibits when deformation of form is forced on them. One of characteristics is near to that of a metal material such that at first it creates elastic deformation according to Young's modulus in a manner of a metal and plastic deformation for larger one. As another characteristic of the layer of cured adhesive, when deformation in form is forced such as hard rubber having a high degree of crosslinking, it is broken if the deformation is large one as tearing off crosslinking portions It becomes a key to decide which this object of cured adhesive is. Of course, the present inventor decided that, for synthetic resin material containing no reinforcing fiber, deformation created when forced to change form by external force or changing temperature is near to that of hard rubber, that is, of latter case. Therefore, forecasting was made about whether portion of adhesion is delaminated or not, by modelling as shown in FIGS. 10(a) to 14(c) and seeing dimensions and change in form.

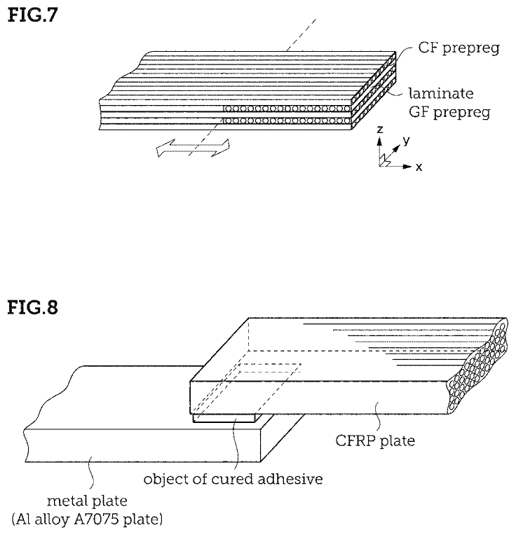

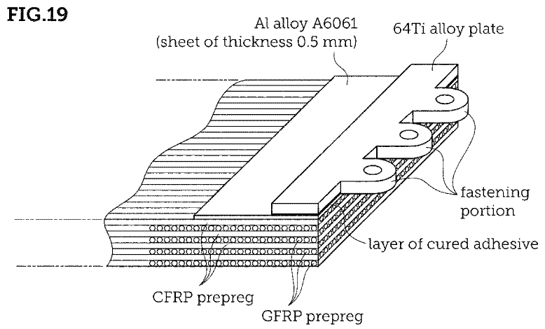

For FRP shown in FIG. 7, form of an integrated FRP, in which CFRP prepregs and GFRP prepregs are laminated with directions of fiber crossed at an angle of 90 degrees, in the right side of the FRP. For coefficient of linear expansion of the upper face, that is a face of the plate, coefficient of linear expansion is taken as 0.1×10⁻⁵K⁻¹ for lengthwise direction (x axis direction) and (0.7 to 0.8)×10⁻⁵ K⁻¹ in a level of GF for width direction (y axis direction), seeing it to be coincident with the above consideration. When a structure of a wing of an airplane, etc., is formed with CFRP actually, a large FRP having a form shown in FIG. 7 (for example, length of 2 m, width of 2 m and thickness of 30 mm with GFRP prepreg on the right side having a length in x axis direction of 50 cm) is formed and a portion of FRP at the right end with both CF and GF used has a dimension of length of 2 m, width of 50 mm and thickness of 10 mm. As shown in FIG. 19, an article of FRP material joined by adhesion with 64 Ti alloy plate is formed in which a 64 Ti alloy plate having a three semi-island shape is joined by adhesion in the right end thereof in a large area near to the Ti alloy plate. In this, trying to attain the object actually, strength of adhesion of epoxy adhesive between the FRP material and the 64 Ti alloy plate is required to be reliable. In order to improve fastening strength of the fastened portion explained above, a sheet of Al alloy A6061 should be joined by adhesion before adhesion of 64 Ti alloy plate at a necessary position thereof. Therefore, a sheet of Al alloy A6061 having a dimension of length of 2 mm, width of 100 mm and thickness of 0.5 mm is prepared and, after having been subjected to NAT treatment, is joined by a wet adhesion method with a portion of FRP, thus forming a large plate of FRP with a sheet of Al alloy attached thereto for its form. This image is as shown in FIG. 19. In a case of fastening structure shown in FIG. 19, a hole for bolt is formed for each of flanges of island-shape so as to be used for fastening to the body.

Dimension of 4 Ti alloy plate to be joined by adhesion with FRP is length of 2 m, width of 50 m and thickness of 10 mm, for example, and three flanges are provided therein, and area of 2 m×50 mm a portion of adhesion after New NMTR treatment for joining by injection molding is secured. In order to form a peripheral wall (for retaining adhesive) with a bottom width of 4 mm and head portion width of 2 mm through joining by injection molding, an injection molding instrument and a metallic mold therefor is prepared. PPS resin “SGX120” as this resin to be injected is injected into the metallic mold to form this peripheral wall, and thickness of the layer of adhesive to be required actually is calculated. A model of a portion of adhesion on the metal side is, for example, as shown in FIG. 18.

The face of adhesion is of a rectangular form of 199.2 cm (2 m-4 mm×2) and 4.2 cm (50 mm-4 mm×2). For the longer side of about 2 m, coefficient of linear expansion is (0.7 to 0.8)×10⁻⁵K⁻¹ as the direction is same as GF fiber, substantially same as coefficient of linear expansion of 64 Ti alloy. For the other side of 4.2 cm, coefficient of linear expansion near to coefficient of CF. This width of 4.2 cm is related to width of 4.2 cm on the 64 Ti alloy side. When temperature is lowered by 200° C. from +150° C. to −50° C., FRP side becomes smaller by 0.1×10⁻⁵K⁻¹×200° C.×4.2 cm=0.0084 cm, being reduced to 4.0916 cm. The other Ti alloy side becomes smaller by 0.8×10⁻⁵K⁻¹×200° C.×4.2 cm=0.00672 cm, being reduced to 4.1933 cm. As difference of dimension is 4.1933-4.0916=0.1017. As shown in FIGS. 11(a) and 11(b), bottom width of the small triangles at both ends is 0.1017/2=0.0508 cm and height of the small triangle as thickness of the layer of adhesive is 0.5 mm. This corresponds just to such as show in right-lower side of FIGS. 11(a) and 11(b). This is of a level providing no problem at all.

In such a manner, it can be understood that thickness of a layer of adhesive of 0.5 mm creates no problem only with simulation by thought. Of course, implementation of it is not possible only with knowledge of Experiment Examples 6 and 7, but it is necessary to prepare a model for experiment corresponding to an actually used object and to repeat thermal shock tests. Considering that there was substantially no example using an object in which GFRP and CFRP prepregs are laminated together as in the present invention, specifically experiment with actual objects is necessary. That is, products of GFRP implemented at present called as glass epoxy are used for electric products or in the field of civil engineering and construction. This is an object in which GFRP prepregs are laminated together using thermosetting epoxy resin as matrix resin, thus its producing process is same as in a case of CFRP. However, there are such matters that thickness of fiber or constituency of thermosetting epoxy resin are different from each other, there is a case where tow component epoxy adhesive is used, for example, or mechanical performance or heat resistance ability required for a DFRP product is different. Due to this, GFRP prepreg and CFRP prepreg are dealt with in a same column. If form of fiber is similar and matrix resin same as for CFRP is to be prepared, almost of all raw materials for GFRP commercially available at present cannot be used as they are, thus requiring substantial amount of work, such as developing it by oneself or purchasing from a current producer of CFRP, though being possible.

With advancement considering that what is possible technically is attained by actually doing so, even if much expense is required therefor. While such intermediate operations are omitted in this experiment example, it is considered that GFRP will come to be able to be dealt with in a similar manner as CFRP and it is not so difficult matter, thus will be attained necessarily. With the present invention, it was decided based on calculation about whether a problem occurs on a portion of adhesion with a metal in a product decided to be possible, for example a composite part shown in FIG. 19 having been subjected to a three thousand cycle thermal shock test, and decided it to be possible. In short, it is assumed that an object of cured adhesive having thickness of layer of cured adhesive of 0.5 mm or so has a sufficient life time.

What is claimed is:

1. A method for producing an integrated article of FRP joined by adhesion with a metal material to form an integrated object, formed by laminating:
a plate material of FRP prepared by laminating CFRP prepregs having carbon fiber aligned in uni-direction so as to cause the carbon fiber to cross each other or by laminating CFRP prepregs having woven cloth of carbon fiber, and
a plate material of Ti alloy to be joined by adhesion with the plate material of FRP at the plate face or side face thereof;
wherein said method comprising:
a step of forming a surrounding wall that can retain liquid with a height of 0.3 to 2.0 mm by injection molding by inserting the plate material of Ti alloy with the surface thereof having been subjected to chemical treatment into a metallic mold for injection molding to form the surrounding wall,
a step of filling adhesive by filling inside of the surrounding wall on the plate material of Ti alloy with epoxy resin adhesive before curing by heating,
a step of painting by painting epoxy resin adhesive before curing by heating onto a surface of one selected from the plate of FRP and the plate material of Ti alloy,
a step of joining by pressing the surrounding wall filled with the epoxy resin adhesive before curing onto the selected surface, and
a step of curing adhesive by heating the joined article along with the epoxy resin adhesive before curing to cause the epoxy resin adhesive to be cured.

2. A method for producing an integrated article of FRP joined by adhesion with a metal material to form an integrated object, formed by laminating:
a plate material of FRP prepared by laminating CFRP prepregs or CFRTP prepregs having carbon fiber aligned in uni-direction so as to align direction of the carbon fiber or by laminating CFRP or CFRTP prepregs prepregs having woven cloth of carbon fiber,
a metal sheet with a thickness of 0.2 to 1.0 mm having one face thereof secured to the plate material of FRP and the other face having been subjected to chemical treatment, and
a plate material of Ti alloy to be joined by adhesion with the metal sheet at the other face thereof;
said method comprising:
a step of forming a surrounding wall that can retain liquid with a height of 0.3 to 2.0 mm by injection molding by inserting the plate material of Ti alloy or the metal sheet with the surface thereof having been subjected to chemical treatment into a metallic mold for injection molding to form the surrounding wall,
a step of filling adhesive by filling inside of the surrounding wall on the plate material of Ti alloy or metal sheet with epoxy resin adhesive before curing by heating,
a step of painting by painting epoxy resin adhesive before curing by heating onto a surface of one selected from the plate of FRP, the plate material of Ti alloy and the metal sheet,
a step of joining by pressing the surrounding wall filled with the epoxy resin adhesive before curing onto the selected surface, and
a step of curing adhesive by heating the joined article along with the epoxy resin adhesive before curing to cause the epoxy resin adhesive to be cured.

3. A method for producing an integrated article of FRP joined by adhesion with a metal material to form an integrated object, formed by laminating:
a plate material of FRP prepared by laminating CFRP prepregs having carbon fiber aligned in uni-direction and GFRP prepregs having glass fiber aligned in uni-direction crossing the carbon fiber, and
a plate material of Ti alloy to be joined by adhesion with the plate material of FRP at the plate face or side face thereof;
said method comprising:
a step of forming a surrounding wall that can retain liquid with a height of 0.3 to 2.0 mm by injection molding by inserting the plate material of Ti alloy with the surface thereof having been subjected to chemical treatment into a metallic mold for injection molding to form the surrounding wall,
a step of filling adhesive by filling inside of the surrounding wall on the metal material or metal sheet with epoxy resin adhesive before curing by heating,
a step of painting by painting epoxy resin adhesive before curing by heating onto a surface of one selected from the plate of FRP and the metal material,
a step of joining by pressing the surrounding wall filled with the epoxy resin adhesive before curing by heating onto the selected surface, and
a step of curing adhesive by heating the joined article along with the epoxy resin adhesive before curing to cause the epoxy resin adhesive to be cured.

4. A method for producing the integrated article of FRP joined by adhesion with a metal material to form an integrated object, formed by laminating:
a plate material of FRP prepared by laminating CFRP prepregs having carbon fiber aligned in uni-direction and GFRP prepregs having glass fiber aligned in uni-direction crossing the carbon fiber,
a metal sheet with a thickness of 0.2 to 1.0 mm having one face thereof secured to the plate material of FRP and the other face having been subjected to chemical treatment, and
a plate material of Ti alloy to be joined by adhesion with the metal sheet at the other face thereof;
said method comprising:
a step of forming a surrounding wall that can retain liquid with a height of 0.3 to 2.0 mm by injection molding by inserting the plate material of Ti alloy or the metal sheet with the surface thereof having been subjected to chemical treatment into a metallic mold for injection molding to form the surrounding wall,
a step of filling adhesive by filling inside the surrounding wall on the metal material or metal sheet with epoxy resin adhesive before curing by heating,
a step of painting by painting epoxy resin adhesive before curing by heating onto a surface of one selected from the plate of FRP, the metal material and the metal sheet,
a step of joining by pressing the surrounding wall filled with the epoxy resin adhesive before curing by heating onto the selected surface, and
a step of curing adhesive by heating the joined article along with the epoxy resin adhesive before curing to cause the epoxy resin adhesive to be cured.

5. The method for producing the integrated article of FRP joined by adhesion with a metal material to form an integrated object according to a claim 1,
wherein the method further comprises a step of degassing of gas in the epoxy resin adhesive before curing by repeated operation of decompressing and returning to an ordinary pressure for the epoxy resin adhesive before curing, after the step of filling with adhesive and the step of painting adhesive.

6. The method for producing the integrated article of FRP joined by adhesion with a metal material to form an integrated object according to a claim 2,
wherein the method further comprises a step of degassing of gas in the epoxy resin adhesive before curing by repeated operation of decompressing and returning to an ordinary pressure for the epoxy resin adhesive before curing, after the step of filling with adhesive and the step of painting adhesive.

7. The method for producing the integrated article of FRP joined by adhesion with a metal material to form an integrated object according to a claim 3,
wherein the method further comprises a step of degassing of gas in the epoxy resin adhesive before curing by repeated operation of decompressing and returning to an ordinary pressure for the epoxy resin adhesive before curing, after the step of filling with adhesive and the step of painting adhesive.

8. The method for producing the integrated article of FRP joined by adhesion with a metal material to form an integrated object according to a claim 4,
wherein the method further comprises a step of degassing of gas in the epoxy resin adhesive before curing by repeated operation of decompressing and returning to an ordinary pressure for the epoxy resin adhesive before curing, after the step of filling with adhesive and the step of painting adhesive.
